(19) United States
(12) Patent Application Publication
(10) Pub. No.: US 2022/0343767 A1
(43) Pub. Date: Oct. 27, 2022

(54) SYSTEMS AND METHODS FOR UNMANNED AERIAL VEHICLE SIMULATION TESTING

(71) Applicant: Iris Automation, Inc., San Francisco, CA (US)

(72) Inventors: Patricio Alejandro Galindo, San Francisco, CA (US); Eric Schafer, Kentfield, CA (US); Nikhilesh Ravishankar, San Francisco, CA (US)

(73) Assignee: Iris Automation, Inc., San Francisco, CA (US)

(21) Appl. No.: 17/719,020

(22) Filed: Apr. 12, 2022

Related U.S. Application Data
(60) Provisional application No. 63/174,139, filed on Apr. 13, 2021.

(51) Int. Cl. G08G 5/00; B64C 39/02; G05D 1/10

(52) U.S. Cl. CPC G08G 5/003; B64C 39/024; G05D 1/101; B64C 2201/141; B64C 2201/127

(57) ABSTRACT

Systems and methods for generating testing and training cases for a simulator based on simulated events are disclosed. The system can monitor an input from a first simulation of a first test case, and detect, based on the input from the first simulation, a target condition resulting from the first test case. The system can identify, based on the target condition, first simulation parameters of the first test case associated with the target condition. The system can generate a second test case having second simulation parameters by modifying the first simulation parameters of the first test case, and output the second test case to a flight autonomy system. The system can provide the generated test cases for the flight autonomy system and can monitor the real-time performance of the simulation of the flight autonomy system.

### CROSS-REFERENCE TO RELATED APPLICATIONS

The present application claims the benefit of and priority to U.S. Provisional Patent Application No. 63/174,139, filed on Apr. 13, 2021, the contents of which is incorporated herein by reference in its entirety for all purposes.

### BACKGROUND

Autonomous Unmanned Aerial Vehicles (UAVs) include onboard control systems that are capable of navigating the UAVs, in some instances without relying on human assistance.

### SUMMARY

At least one aspect of the present disclosure relates to a method for generating and training test cases for a simulator based on simulated target events. The method can include monitoring an output from a first simulation of a first test case. The method can include detecting, based on the output from the first simulation, a target condition resulting from the first test case. The method can include identifying, based on the target condition, first simulation parameters of the first test case associated with the target condition. The method can include generating a second test case having second simulation parameters by modifying the first simulation parameters of the first test case. The method can include outputting the second test case.

In some implementations of the method, the first test case can be selected from a plurality of first test cases having simulation parameters within a first parameter range. In some implementations of the method, generating the second test case can include generating a plurality of second test cases having a simulation parameter within a second parameter range. In some implementations of the method, the second parameter range can be broader than the first parameter range. In some implementations of the method, generating the second test case can include selecting the second test case from the plurality of second test cases.

In some implementations of the method, the simulation parameter within the second range of boundary conditions can be selected for each of the plurality of second test cases based on the target condition resulting from the first test case. In some implementations, the method can further include determining the second range of parameter values based on the first range of parameter values and a simulation rate of the target condition. In some implementations of the method, the second test case can be stochastically sampled from the plurality of second test cases.

In some implementations of the method, identifying the first simulation parameters of the first test case can include determining a simulation time at which the target condition occurred. In some implementations of the method, identifying the first simulation parameters of the first test case can include identifying one or more conditions of the first test case that occurred prior to the simulation time at which the target condition occurred. In some implementations of the method, identifying the first simulation parameters of the first test case can include extracting the first simulation parameters based on the one or more conditions of the first test case.

In some implementations of the method, each set of the first simulation parameters can be associated with a priority value. In some implementations of the method, extracting the first simulation parameters can include extracting a subset of each set of the first simulation parameters having a respective priority value that satisfies a threshold. In some implementations of the method, the first simulation parameters and the second simulation parameters can include at least one of a velocity value, an altitude value, a location value, a cloud cover value, a cloud type value, a roll value, a pitch value, a yaw value, environmental lighting conditions, or environmental objects. In some implementations of the method, monitoring the output from the first simulation of the first test case can include providing, to the first simulation, one or more conditions of the first test case at predetermined time intervals. In some implementations of the method, monitoring the output from the first simulation of the first test case can include receiving, from the first simulation, feedback information generated in response to the one or more conditions of the first test case as the output from the first simulation.

In some implementations of the method, detecting the target condition resulting from the first simulation can include determining a difference between the output from the first simulation and an expected output value of the first test case. In some implementations of the method, detecting the target condition resulting from the first simulation can include determining the threshold of difference from the first simulation that causes the target condition.

At least one other aspect of the present disclosure relates to a system for generating and training test cases for a simulator based on simulated events. The system can include one or more processors configured by machine-readable instructions. The system can monitor an output from a first simulation of a first test case. The system can detect, based on the output from the first simulation, a target condition resulting from the first test case. The system can identify, based on the target condition, first simulation parameters of the first test case associated with the target condition. The system can generate a second test case having second simulation parameters by modifying the first simulation parameters of the first test case. The system can output the second test case.

In some implementations of the system, the first test case can be selected from a plurality of first test cases having simulation parameters within a first parameter range. In some implementations of the system, generating the second test case can include generating a plurality of second test cases having a simulation parameter within a second parameter range. In some implementations of the system, the second parameter range can be broader than the first parameter range. In some implementations of the system, generating the second test case can include selecting the second test case from the plurality of second test cases.

In some implementations of the system, the simulation parameter within the second range of boundary conditions can be selected for each of the plurality of second test cases based on the target condition resulting from the first test case. In some implementations of the system, the system can determine the second range of parameter values based on the first range of parameter values and a simulation rate of the target condition. In some implementations of the system, the second test case can be stochastically sampled from the plurality of second test cases.

In some implementations of the system, identifying the first simulation parameters of the first test case can include determining a simulation time at which the target condition occurred. In some implementations of the system, identifying the first simulation parameters of the first test case can include identifying one or more conditions of the first test case that occurred prior to the simulation time at which the target condition occurred. In some implementations of the system, identifying the first simulation parameters of the first test case can include extracting the first simulation parameters based on the one or more conditions of the first test case.

In some implementations of the system, each set of the first simulation parameters can be associated with a priority value. In some implementations of the system, extracting the first simulation parameters can include extracting a subset of each set of the first simulation parameters having a respective priority value that satisfies a threshold. In some implementations of the system, the first simulation parameters and the second simulation parameters can include at least one of a velocity value, an altitude value, a location value, a cloud cover value, a cloud type value, a roll value, a pitch value, a yaw value, environmental lighting conditions, or environmental objects.

In some implementations of the system, monitoring the output from the first simulation of the first test case can include providing, to the first simulation, one or more conditions of the first test case at predetermined time intervals. In some implementations of the system, monitoring the output from the first simulation of the first test case can include receiving, from the first simulation, feedback information generated in response to the one or more conditions of the first test case as the output from the first simulation.

In some implementations of the system, detecting the target condition resulting from the first simulation can include determining a difference between the output from the first simulation and an expected output value of the first test case. In some implementations of the system, detecting the target condition resulting from the first simulation can include determining the threshold of difference from the first simulation that causes the target condition.

At least one other aspect of the present disclosure relates to a method for evaluating real-time output from a simulator for flight autonomy systems. The method can include transmitting simulated input of a first test case to a flight autonomy system. The method can include receiving, from the flight autonomy system, response signals generated by the flight autonomy system in response to the simulated input of the first test case. The method can include generating a second test case based on the response signals received from the flight autonomy system. The method can include transmitting a second simulated input of the second test case to the flight autonomy system.

In some implementations of the method, the first test case can have first simulation parameters within a first parameter range. In some implementations of the method, generating the second test case can include generating second simulation parameters for the second test case within a second parameter range that is narrower than the first parameter range. In some implementations of the method, transmitting the second simulated input of the second test case to the flight autonomy system can cause the flight autonomy system to operate based on the second test case.

In some implementations of the method, the simulated input can include one or more conditions at predetermined simulation time intervals. In some implementations of the method, receiving response signals can occur in response to the one or more conditions provided as input to the flight autonomy system. In some implementations of the method, receiving the response signals can include receiving, from the flight autonomy system, an indication that the response signals satisfy at least one target condition.

In some implementations of the method, transmitting the simulated input of the first test case can include generating simulated video data based on simulation parameters of the first test case. In some implementations of the method, transmitting the simulated input of the first test case can include transmitting the simulated video data to a video input of the flight autonomy system. In some implementations of the method, transmitting the simulated input of the first test case can include generating telemetry data including at least one of location information, velocity information, or orientation information. In some implementations of the method, transmitting the simulated input of the first test case can include transmitting the telemetry data to a telemetry input of the flight autonomy system.

In some implementations of the method, generating the second test case can include evaluating the response signals from the flight autonomy system against expected response values of the first test case. In some implementations of the method, generating the second test case can include determining from the evaluation of the response data, that the response signals satisfy at least one target condition. In some implementations of the method, generating the second test case can include generating the second test case in response to determining that the response signals satisfy at least one target condition.

In some implementations of the method, evaluating the response signals received from the flight autonomy system can include determining a difference between the response signals from the flight autonomy system and the expected response values. In some implementations of the method, determining that the response can signal satisfy at least one target condition is responsive to determining that the difference satisfies a target condition threshold. In some implementations, the method can include evaluating the response signals received from the flight autonomy system against expected response values for the first test case. In some implementations, the method can include determining that evaluating the response signals occurs over a time period that exceeds a predetermined threshold. In some implementations, the method can include transmitting a time control signal to the flight autonomy system in response to determining that the time period exceeds the predetermined threshold.

In some implementations, the method can include transmitting, to the flight autonomy system, simulation information corresponding to a first time step of the first test case. In some implementations, the method can include evaluating response signals generated by the flight autonomy system corresponding to the first time step. In some implementations, the method can include simulating, responsive to evaluating the response signals generated by the flight autonomy system corresponding to the first time step, a second time step of the first test case.

At least one other aspect of the present disclosure relates to a system for evaluating real-time output from a simulator for flight autonomy systems. The system can include one or more processors coupled to memory. The system can transmit simulated input of a first test case to the flight autonomy system. The system can receive, from the flight autonomy system, response signals generated by the flight autonomy system in response to the simulated input of the first test case. The system can generate a second test case based on the response signals received from the flight autonomy system. The system can transmit a second simulated input of the second test case to the flight autonomy system.

In some implementations of the system, the first test case can have first simulation parameters within a first parameter range. In some implementations of the system, generating the second test case can include generating second simulation parameters for the second test case within a second parameter range that is narrower than the first parameter range. In some implementations of the system, transmitting the second simulated input of the second test case to the flight autonomy system can cause the flight autonomy system to operate based on the second test case.

In some implementations of the system, the simulated input can include one or more conditions at predetermined simulation time intervals. In some implementations of the system, receiving response signals can occur in response to the one or more conditions provided as input to the flight autonomy system. In some implementations of the system, receiving the response signals can include receiving, from the flight autonomy system, an indication that the response signals satisfy at least one target condition.

In some implementations of the system, transmitting the simulated input of the first test case can include generating simulated video data based on simulation parameters of the first test case. In some implementations of the system, transmitting the simulated input of the first test case can include transmitting the simulated video data to a video input of the flight autonomy system. In some implementations of the system, transmitting the simulated input of the first test case can include generating telemetry data including at least one of location information, velocity information, or orientation information. In some implementations of the system, transmitting the simulated input of the first test case can include transmitting the telemetry data to a telemetry input of the flight autonomy system.

In some implementations of the system, generating the second test case can include evaluating the response signals from the flight autonomy system against expected response values of the first test case. In some implementations of the system, generating the second test case can include determining from the evaluation of the response data, that the response signals satisfy at least one target condition. In some implementations of the system, generating the second test case can include generating the second test case in response to determining that the response signals satisfy at least one target condition. In some implementations of the system, evaluating the response signals received from the flight autonomy system can include determining a difference between the response signals from the flight autonomy system and the expected response values. In some implementations of the system, determining that the response signal satisfies at least one target condition is responsive to determining that the difference satisfies a target condition threshold.

In some implementations of the system, the system can evaluate the response signals received from the flight autonomy system against expected response values for the first test case. In some implementations of the system, the system can determine that evaluating the response signals occurs over a time period that exceeds a predetermined threshold. In some implementations of the system, the system can transmit a time control signal to the flight autonomy system in response to determining that the time period exceeds the predetermined threshold.

In some implementations of the system, the system can transmit, to the flight autonomy system, simulation information corresponding to a first time step of the first test case. In some implementations of the system, the system can evaluate response signals generated by the flight autonomy system corresponding to the first time step. In some implementations of the system, the system can simulate, responsive to evaluating the response signals generated by the flight autonomy system corresponding to the first time step, a second time step of the first test case.

One aspect of the present disclosure relates to a method for generating simulated flight paths using inverse kinematics. The method can include identifying a sequence of sensor information corresponding to an aerial flight or a hypothetical flight. The method can include determining, based on the sequence of sensor information, a flight path of the aerial flight including a plurality of waypoints. The method can include generating instructions for a flight control system that, when executed, cause the flight control system to navigate a simulated movable object along a simulated flight path that corresponds to the plurality of waypoints. The method can include providing the instructions to a simulator as part of a test case for the flight control system.

In some implementations of the method, identifying the sequence of sensor information can include retrieving a sequence of inertial measurement unit data structures including at least one of a sequence of acceleration values, a sequence of gyroscope values, or a sequence of magnetometer values. In some implementations of the method, identifying the sequence of sensor information can include generating a synchronized sequence of sensor data structures as the sequence of sensor information by synchronizing the sequence of IMU data structures to a sequence of global positioning system data structures.

In some implementations of the method, identifying the sequence of sensor information can further include retrieving one or more of a sequence of radar data structures generated by a radar sensor, a sequence of global positioning system data structures, a sequence of signal triangulation data structures, a sequence of data structures generated by a stereo camera pair, or a selection of a type of aircraft that conducted the aerial flight. In some implementations of the method, determining the flight path can further include calculating, using the sequence of sensor information, one or more of a sequence of position data structures, a sequence of heading data structures, a sequence of altitude data structures, or a sequence of time data structures. In some implementations of the method, determining the flight path can further include generating the plurality of waypoints of the flight path based on one or more of the sequence of position data structures, the sequence of heading data structures, the sequence of altitude data structures, or the sequence of time data structures.

In some implementations of the method, the plurality of waypoints can form an ordered list of waypoints. In some implementations of the method, determining the flight path can further include interpolating a third waypoint between a first waypoint of the ordered list of waypoints and a second waypoint of the ordered list of waypoints. In some implementations of the method, determining the flight path can further include storing the third waypoint as part of the ordered list of waypoints between the first waypoint and the second waypoint.

In some implementations of the method, generating the instructions can include determining one or more commands that cause the flight control system to actuate simulated flight controls that cause the movable object to follow the simulated flight path. In some implementations of the method, the one or more commands can cause the flight controller to change, in a simulation, at least one of a velocity of the movable entity, an acceleration of the movable entity, an altitude of the movable entity, or an orientation of the movable entity. In some implementations, the method can include retrieving, from a camera, a sequence of images captured from the aerial flight. In some implementations, the method can include synchronizing the sequence of images captured from the aerial flight to the instructions for the flight control system. In some implementations, the method can include providing the synchronized sequence of images to a video input of the flight control system as part of the test case.

In some implementations, the method can include generating based on the sequence of sensor information, instructions to control an orientation of a platform on which the flight control system is positioned. In some implementations, the method can include providing the instructions to control the orientation of the platform to the simulator as a second part of the first test case. In some implementations, the method can include further including generating the test case such that the flight control system navigates the simulated movable object along the simulated flight path. In some implementations of the method, the test case can terminate when the simulated movable object reaches an endpoint of the simulated flight path.

At least one other aspect of the present disclosure relates to a system for generating simulated flight paths using inverse kinematics. The system can include one or more processors coupled to memory. The system can identify a sequence of sensor information captured corresponding to an aerial flight or a hypothetical flight. The system can determine, based on the sequence of sensor information, a flight path of the aerial flight including a plurality of waypoints. The system can generate instructions for a flight control system that, when executed, cause the flight control system to navigate a simulated movable object along a simulated flight path that corresponds to the plurality of waypoints. The system can provide the instructions to a simulator as part of a test case for the flight control system.

In some implementations of the system, identifying the sequence of sensor information can include retrieving a sequence of inertial measurement unit data structures including at least one of a sequence of acceleration values, a sequence of gyroscope values, or a sequence of magnetometer values. In some implementations of the system, identifying the sequence of sensor information can include generating a synchronized sequence of sensor data structures as the sequence of sensor information by synchronizing the sequence of IMU data structures to a sequence of global positioning system data structures.

In some implementations of the system, identifying the sequence of sensor information can further include retrieving one or more of a sequence of radar data structures generated by a radar sensor, a sequence of global positioning system data structures, a sequence of signal triangulation data structures, a sequence of data structures generated by a stereo camera pair, or a selection of a type of aircraft that conducted the aerial flight. In some implementations of the system, determining the flight path can further include calculating, using the sequence of sensor information, one or more of a sequence of position data structures, a sequence of heading data structures, a sequence of altitude data structures, or a sequence of time data structures. In some implementations of the system, determining the flight path can further include generating the plurality of waypoints of the flight path based on one or more of the sequence of position data structures, the sequence of heading data structures, the sequence of altitude data structures, or the sequence of time data structures.

In some implementations of the system, the plurality of waypoints can form an ordered list of waypoints. In some implementations of the system, determining the flight path can further include interpolating a third waypoint between a first waypoint of the ordered list of waypoints and a second waypoint in the ordered list of waypoints. In some implementations of the system, determining the flight path can further include storing the third waypoint as part of the ordered list of waypoints between the first waypoint and the second waypoint. In some implementations of the system, generating the instructions can include determining one or more commands that cause the flight control system to actuate simulated flight controls that cause the movable object to follow the simulated flight path.

In some implementations of the system, the one or more commands can cause the flight controller to change, in a simulation, at least one of a velocity of the movable entity, an acceleration of the movable entity, an altitude of the movable entity, or an orientation of the movable entity.

In some implementations of the system, the system can retrieve, from a camera, a sequence of images captured from the aerial flight. In some implementations of the system, the system can synchronize the sequence of images captured from the aerial flight to the instructions for the flight control system. In some implementations of the system, the system can provide the synchronized sequence of images to a video input of the flight control system as part of the test case.

In some implementations of the system, the system can generate based on the sequence of sensor information, instructions to control an orientation of a platform on which the flight control system is positioned. In some implementations of the system, the system can provide the instructions to control the orientation of the platform to the simulator as a second part of the first test case. In some implementations of the system, the system can generate the test case such that the flight control system navigates the simulated movable object along the simulated flight path. In some implementations of the system, the test case can terminate when the simulated movable object reaches an endpoint of the simulated flight path.

At least one aspect of the present disclosure relates to a method for generating a realistic turbulence model for a flight simulator. The method can include identifying a sequence of sensor information captured from an aerial flight. The method can include extracting a frequency component from the sequence of sensor information. The method can include establishing, based on the frequency component extracted from the sequence of sensor information, a model of attitude corrections that occurred during the aerial flight. The method can include generating a series of simulated turbulence values based on the model of attitude corrections. The method can include providing the series of simulated turbulence values to a simulator for realistic data rendering.

In some implementations of the method, identifying the sequence of sensor information can include retrieving a sequence of inertial measurement unit data structures including at least one of a sequence of roll values, a sequence of pitch values, or a sequence of yaw values. In some implementations of the method, identifying the sequence of sensor information can include generating a time-series data structure including the sequence of IMU data structures as at least a part of the sequence of sensor information.

In some implementations of the method, extracting the frequency component from the sequence of sensor information can include determining a Fourier transform of at least one of the sequence of roll values, the sequence of pitch values, or the sequence of yaw values. In some implementations of the method, extracting the frequency component from the sequence of sensor information can include identifying a subset of frequency components of the Fourier transform having magnitudes greater than other frequency components of the Fourier transform. In some implementations of the method, extracting the frequency component from the sequence of sensor information can include extracting at least one of the subset of frequency components as the frequency component.

In some implementations, the method can include further including extracting, by the one or more processors, a phase component from the sequence of sensor information. In some implementations of the method, establishing the model of attitude variations of the aerial flight can be further based on the phase component.

In some implementations of the method, establishing the model of attitude corrections can further include establishing, based on the frequency component extracted from the sequence of sensor information, at least one of a model for roll corrections that occurred during the aerial flight, a model for pitch corrections that occurred during the aerial flight, or a model for yaw corrections that occurred during the aerial flight. In some implementations of the method, generating the series of simulated turbulence values can be based on at least one of the models for roll corrections, the model for pitch corrections, or the model for yaw corrections.

In some implementations of the method, the model of attitude corrections can be a Fourier series model. In some implementations of the method, establishing the model of attitude corrections can further include determining a Fourier series coefficient for the frequency component of the Fourier series model. In some implementations of the method, generating the series of simulated turbulence values can be based in part on the Fourier series coefficient of the Fourier series model.

In some implementations of the method, determining the Fourier series coefficient can include determining variations in the Fourier series coefficient based on a velocity value of a movable object that performed the aerial flight. In some implementations of the method, generating the series of simulated turbulence values can further include generating a series of telemetry data as the series of turbulence values. In some implementations of the method, the series of telemetry data can include at least one of a series of simulated roll values, a series of simulated pitch values, and a series of simulated yaw values.

In some implementations, the method can include identifying a frequency value of a video stream captured during the aerial flight. In some implementations, the method can include interpolating the series of telemetry data to match the frequency value of the video stream. In some implementations, the method can include generating a simulated video input stream by associating each of the series of telemetry data with a corresponding frame in the video stream captured during the aerial flight.

In some implementations of the method, providing the series of simulated turbulence values to a simulator can further include providing the simulated video input to the simulator to cause the simulator to output the simulated video input.

Another aspect of the present disclosure relates to a system configured for generating a realistic turbulence model for a flight simulator. The system can include one or more processors coupled to memory. The system can identify a sequence of sensor information captured from an aerial flight. The system can extract a frequency component from the sequence of sensor information. The system can establish, based on the frequency component extracted from the sequence of sensor information, a model of attitude corrections that occurred during the aerial flight. The system can generate a series of simulated turbulence values based on the model of attitude corrections. The system can provide the series of simulated turbulence values to a simulator for realistic data rendering.

In some implementations of the system, identifying the sequence of sensor information can include retrieving a sequence of inertial measurement unit data structures including at least one of a sequence of roll values, a sequence of pitch values, or a sequence of yaw values. In some implementations of the system, identifying the sequence of sensor information can include generating a time-series data structure including the sequence of IMU data structures as at least a part of the sequence of sensor information. In some implementations of the system, extracting the frequency component from the sequence of sensor information can include determining a Fourier transform of at least one of the sequence of roll values, the sequence of pitch values, or the sequence of yaw values. In some implementations of the system, extracting the frequency component from the sequence of sensor information can include identifying a subset of frequency components of the Fourier transform having magnitudes greater than other frequency components of the Fourier transform. In some implementations of the system, extracting the frequency component from the sequence of sensor information can include extracting at least one of the subset of frequency components as the frequency component.

In some implementations of the system, the system can extract, by one or more processors, a phase component from the sequence of sensor information. In some implementations of the system, establishing the model of attitude variations of the aerial flight can be further based on the phase component. In some implementations of the system, establishing the model of attitude corrections can further include establishing, based on the frequency component extracted from the sequence of sensor information, at least one of a model for roll corrections that occurred during the aerial flight, a model for pitch corrections that occurred during the aerial flight, or a model for yaw corrections that occurred during the aerial flight. In some implementations of the system, generating the series of simulated turbulence values can be based on at least one of the models for roll corrections, the model for pitch corrections, or the model for yaw corrections.

In some implementations of the system, the model of attitude corrections can be a Fourier series model. In some implementations of the system, establishing the model of attitude corrections can further include determining a Fourier series coefficient for the frequency component of the Fourier series model. In some implementations of the system, generating the series of simulated turbulence values can be based in part on the Fourier series coefficient of the Fourier series model. In some implementations of the system, determining the Fourier series coefficient can include determining variations in the Fourier series coefficient based on a velocity value of a movable object that performed the aerial flight.

In some implementations of the system, generating the series of simulated turbulence values can further include generating a series of telemetry data as the series of turbulence values. In some implementations of the system, the series of telemetry data can include at least one of a series of simulated roll values, a series of simulated pitch values, and a series of simulated yaw values.

In some implementations of the system, the system can identify a frequency value of a video stream captured during the aerial flight. In some implementations of the system, the system can interpolate the series of telemetry data to match the frequency value of the video stream. In some implementations of the system, the system can generate a simulated video input stream by associating each of the series of telemetry data with a corresponding frame in the video stream captured during the aerial flight. In some implementations of the system, providing the series of simulated turbulence values to a simulator can further include providing the simulated video input to the simulator to cause the simulator to output the simulated video input.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. Aspects can be combined and it will be readily appreciated that features described in the context of one aspect of the invention can be combined with other aspects. Aspects can be implemented in any convenient form. For example, by appropriate computer programs, which can be carried on appropriate carrier media (computer readable media), which can be tangible carrier media (e.g. disks) or intangible carrier media (e.g. communications signals). Aspects can also be implemented using suitable apparatus, which can take the form of programmable computers running computer programs arranged to implement the aspect. As used in the specification and in the claims, the singular form of ‘a’, ‘an’, and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 illustrates a block diagram of an example system for generating test cases for a simulator based on simulated events;

FIG. 2 illustrates an example flow diagram of a method for generating test cases for a simulator based on simulated events;

FIG. 3 illustrates a block diagram of an example system for evaluating real-time output from a simulator for flight autonomy systems;

FIG. 4 illustrates an view of an example representation of a flight autonomy system in a simulator environment;

FIG. 5 illustrates an example flow diagram of a method for evaluating real-time output from a simulator for flight autonomy systems;

FIG. 6 illustrates a block diagram of an example system for generating simulated flight paths using inverse kinematics;

FIG. 7 illustrates an example flow diagram of a method for generating simulated flight paths using inverse kinematics;

FIG. 8 illustrates a block diagram of an example system for generating a realistic turbulence model for a flight simulator;

FIG. 9 illustrates a graph of an example comparison between real world turbulence and simulated turbulence information;

FIG. 10 illustrates an example flow diagram of a method for generating a realistic turbulence model for a flight simulator; and

FIGS. 11A and 11B are block diagrams depicting embodiments of computing devices useful in connection with the systems and methods described herein.

### DETAILED DESCRIPTION

Below are detailed descriptions of various concepts related to, and implementations of, techniques, approaches, methods, apparatuses, and systems for generating test cases for a simulator based on simulated events. The various concepts introduced above and discussed in greater detail below can be implemented in any of numerous ways, as the described concepts are not limited to any particular manner of implementation. Examples of specific implementations and applications are provided primarily for illustrative purposes.

For purposes of reading the description of the various embodiments below, the following descriptions of the sections of the Specification and their respective contents can be helpful:

Section A describes techniques for generating and training test cases for a flight autonomy system coupled to a simulator based on simulated events;

Section B describes techniques for evaluating real-time output from a simulator for autonomous flight;

Section C describes techniques for generating simulated flight paths and attitude using inverse kinematics;

Section D describes techniques for generating realistic turbulence models for flight simulators; and

Section E describes a computing environment which can be useful for practicing implementations described herein.

Aircraft and UAV flight autonomy systems should be designed to accurately and quickly respond to new environments and input. However, design techniques for flight autonomy systems cannot anticipate all new environmental factors and inputs. Further, some testing apparatuses are unequipped to simulate environments faced by UAVs and aircraft.

Autonomous and semi-autonomous flying vehicles are complex and expensive to test. Moreover, testing at scale can be challenging to perform for non-safe cases, such as collision avoidance testing or other types of potentially harmful tests. Systems and methods in accordance with the present disclosure can enable an accurate simulation of an actual flight environment to virtually train and test potentially harmful or challenging test cases. The simulator system described herein can provide realistic input into all the sensors of an flight autonomy system, such as a system or a component of a UAV, therefore enabling testing and training at a large scale in any kind of environment of any level of risk. The techniques described herein allow for the simulation of extremely dangerous scenarios at high-fidelity without the risk of harm to the aircraft, harm to the UAV, harm to infrastructure, harm to other aircraft, or harm to people. Rare encounters, or encounters that can be difficult to reproduce, can also be simulated. If desired, the simulations can be configured to be specific, directed with a purpose, or can be of Monte-Carlo nature in order to sample the possibilities in the real world. In order to provide accurate simulations, the environments provided by the simulator using the techniques described, are of high fidelity and could follow the physical rules of the real world. To do so, the system can provide high-fidelity test cases and simulation information to software or hardware in the loop. Realistic flight characteristics of high-fidelity test cases can be generated using inverse kinematics on information captured from real aircraft flights. Additionally, realistic simulated turbulence can be generated and introduced into test cases. In some implementations, a physical platform will follow flight dynamics including yaw, pitch, and roll of the aircraft. Various systems and methods described herein can enable improved simulation and testing of aircraft, including UAVs, improving the operation of the aircraft, including improving performance factors such as timing of decision making and accuracy of decision making (e.g., fewer decisions made by the control systems that result in target conditions, such as failures or other predetermined conditions).

A. Generating Test Cases for a Simulator Based on Simulator Events

Simulator test cases, particularly for autonomous flight systems, can be used to test system responses over a range of simulator parameters. In aircraft systems, and particularly UAV systems, testing and training based on particularly challenging cases can be valuable, because conventional (including manual) generation of test cases will often fail to anticipate certain conditions (e.g., failures, other predetermined conditions, etc.), and it can require significant computational processing resources and time to comprehensively generate and simulate operation over a sufficient range of simulator parameters. The techniques described below provide a Monte-Carlo simulation approach to test case generation that takes into account realistic ranges of system inputs that commonly provide a revealing sample of the real world. This can allow a system to demonstrate how it would perform in the real-world environments. For autonomous systems and in particular, for autonomous systems that fly, failure incidents or other conditions can very easily be catastrophic. Therefore, there is a need to understand and minimize the possibility of an unlikely scenario.

Thus, the techniques described herein provide a system that can explore the ranges of simulator test case parameters in a global Monte-Carlo fashion until a significant number of failure, low performing, or target (e.g., predetermined) scenarios are encountered. When this happens, variables that are not suspected to affect the poor system performance or the target condition are removed from the observation and the Monte-Carlo simulation can proceed with the simulator parameters that could potentially be related to the poor performance of the system. This can allow for the generation “neighboring” configurations that can help operators understand the extent of the failure cases, or the extent of the cases that resulted in a particular target condition. These steps are repeated until certainty is achieved about the relation of factors with bad performance or target performance. For example, this process could reveal that in the presence of cumulus clouds within an hour of sunset the system fails very often. When the number of variables is small enough, univariate testing can be performed to define the functional relation between performance and environmental factors. By encountering these difficult scenarios one can either limit the scope of the system or focus the development of the system so it performs at a desirable level in the difficult conditions

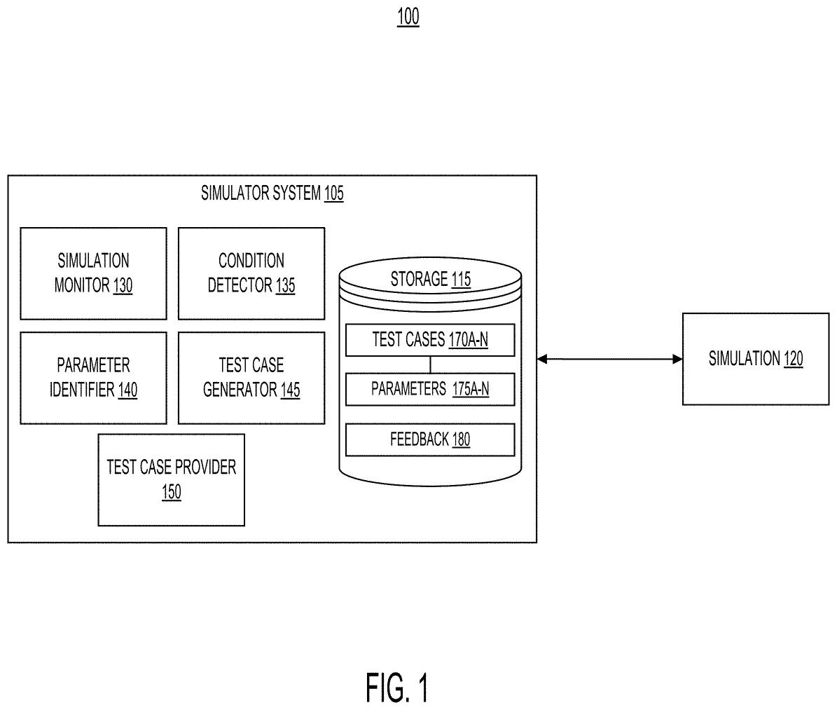

Referring now to FIG. 1, illustrated is a block diagram of an example system 100 for generating test cases for a simulator based on simulated events, in accordance with one or more implementations. The system 100 can include at least one simulator system 105, and at least one simulation 120, The simulator system 105 can include at least one simulation monitor 130, at least one condition detector 135, at least one parameter identifier 140, at least one test case generator 145, at least one test case provider 150, and at least one storage 115. The storage 115 can include one or more test cases 170A-170N (sometimes referred to generally as test case(s) 170), one or more parameters 175A-175N (sometimes referred to generally as parameters(s) 175), and feedback 180 information.

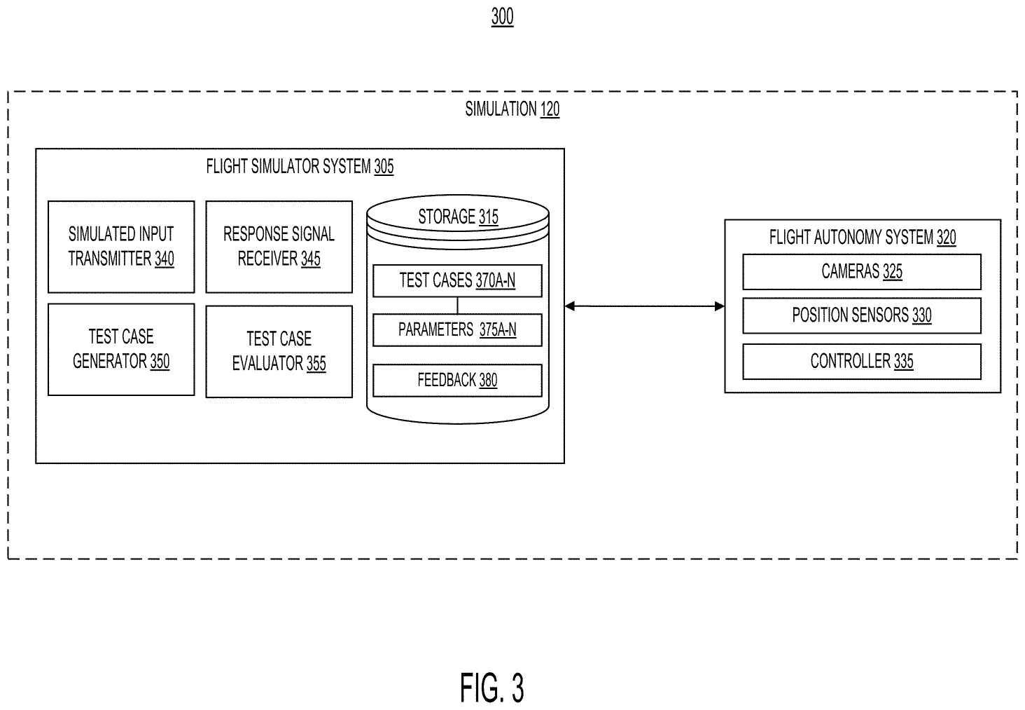

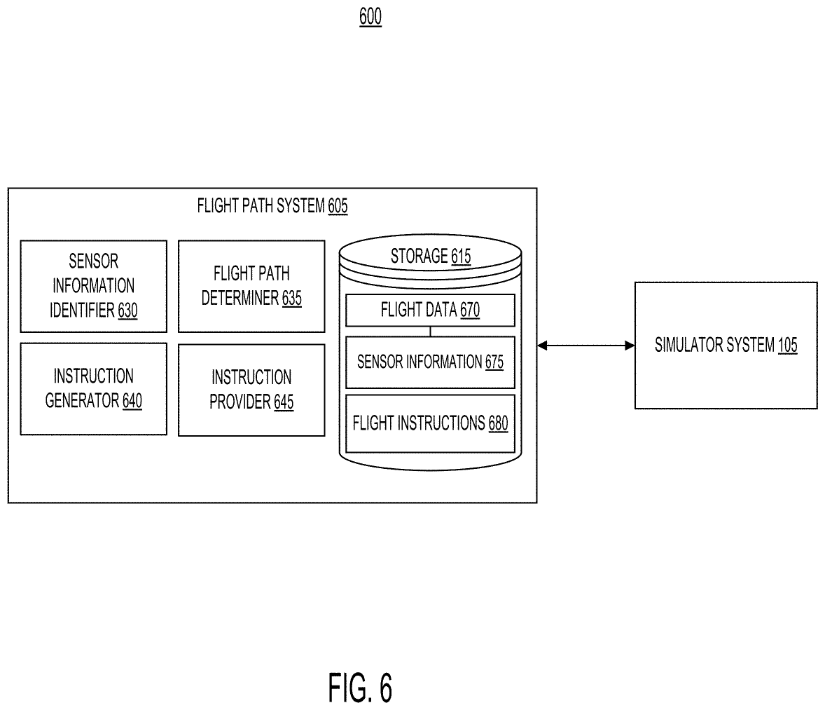

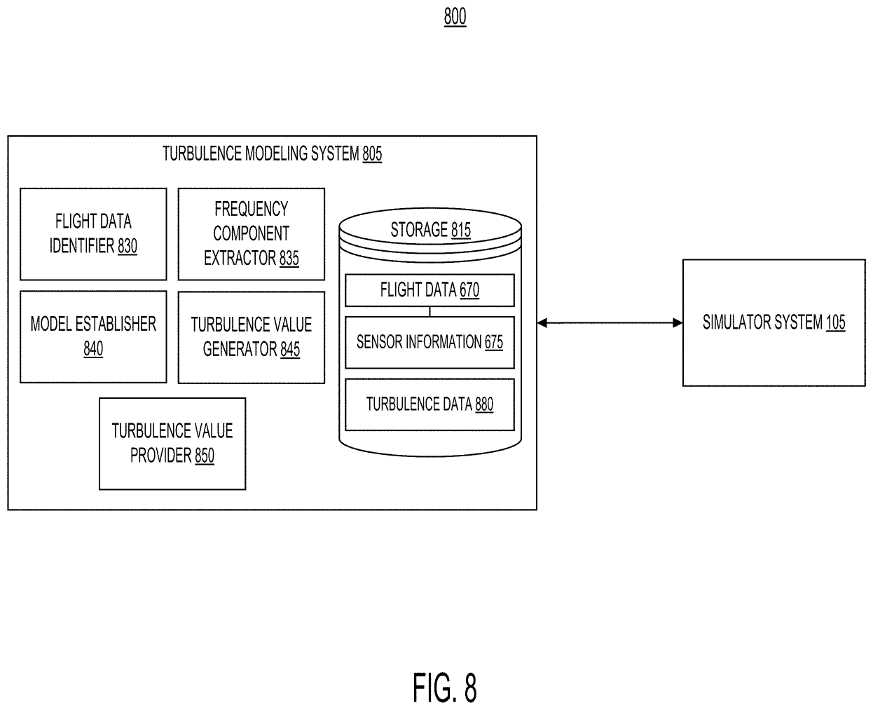

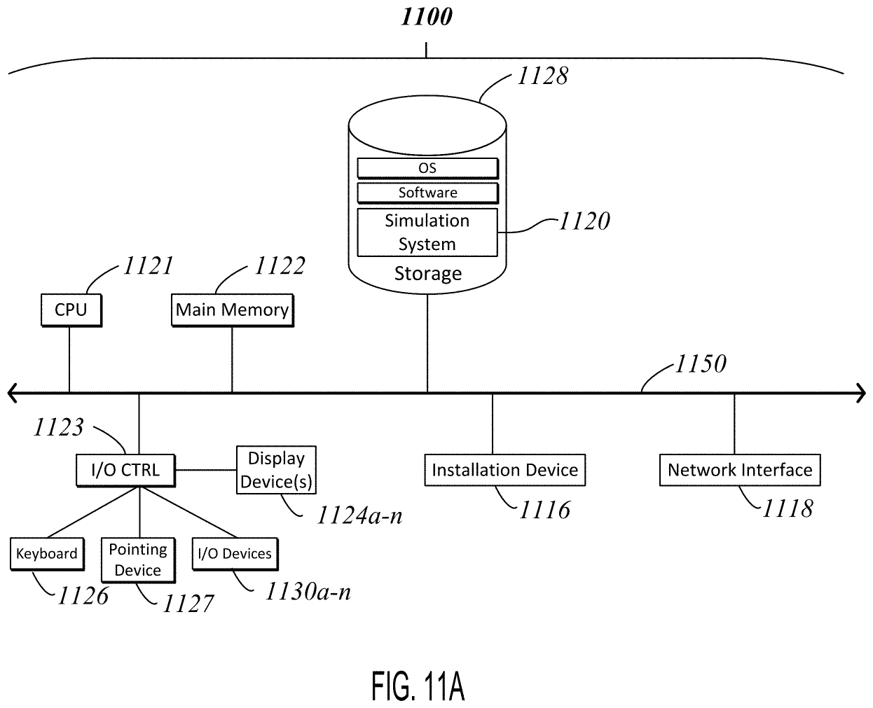

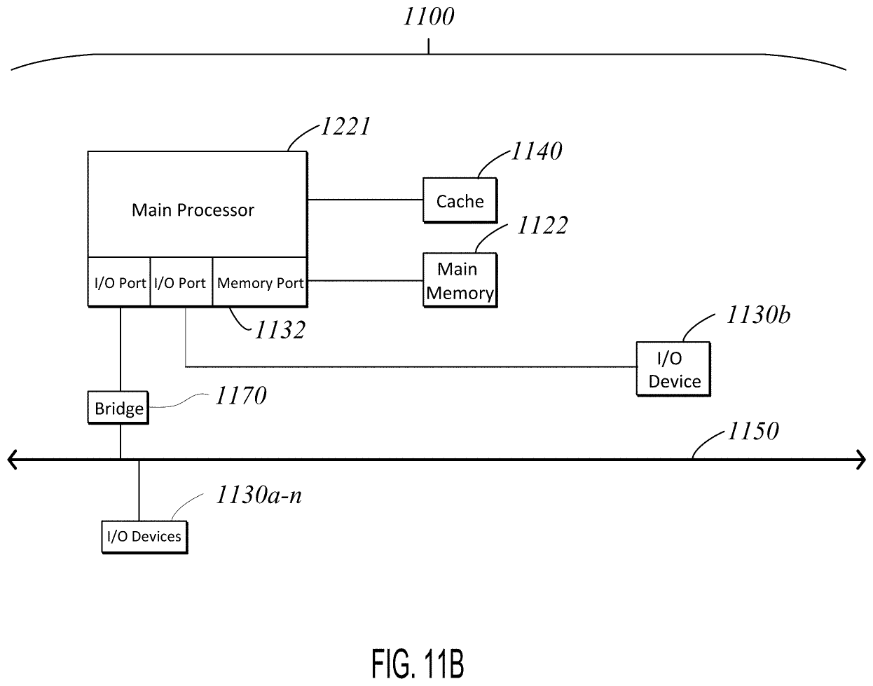

Each of the components (e.g., the simulator system 105, the simulation 120, the simulation monitor 130, the condition detector 135, the parameter identifier 140, the test case generator 145, the test case provider 150, etc.) of the system 100 can be implemented using the hardware components or a combination of software with the hardware components of a computing system (e.g., computing system 1100, any other computing system described herein, etc.) detailed herein in conjunction with FIGS. 11A and 11B. Each of the components of the simulator system 105 can perform the functionalities detailed herein. It should be understood that the simulator system 105 depicted in FIG. 1 can perform all of the functionality of the flight simulator system 305 depicted in FIG. 3, the flight path system 605 depicted in FIG. 6, and the turbulence modeling system 805 depicted in FIG. 8.

The simulator system 105 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), a graphics processing unit (GPU), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The simulator system 105 can include one or more computing devices or servers that can perform various functions as described herein. The simulator system 105 can include any or all of the components and perform any or all of the functions of the computer system 1100 described herein in conjunction with FIGS. 11A and 11B.

The storage 115 can be a database, or another type of computer memory storage, configured to store and/or maintain any of the information described herein. The storage 115 can maintain one or more data structures, which can contain, index, or otherwise store each of the values, pluralities, sets, variables, vectors, or thresholds described herein. The storage 115 can be accessed using one or more memory addresses, index values, or identifiers of any item, structure, or region maintained in the storage 115. The storage 115 can be accessed by the components of the simulator system 105, or any other computing device described herein, via a network or another type of communications interface. In some implementations, the storage 115 can be internal to the simulator system 105. In some implementations, the storage 115 can exist external to the simulator system 105, and can be accessed via a network or another type of communications interface. In some implementations, the storage 115 can be distributed across many different computer systems or storage elements. The simulator system 105 can store, in one or more regions of the memory of the simulator system 105, or in the storage 115, the results of any or all computations, determinations, selections, identifications, generations, constructions, or calculations in one or more data structures indexed or identified with appropriate values. Any or all values stored in the storage 115 can be accessed by any computing device described herein, such as the simulator system 105, to perform any of the functionalities or functions described herein.

The simulation 120 can be any type of simulation that is integrated that provides feedback in response to various test cases. For example, the simulation 120 can be a flight autonomy system that provides real-time feedback to telemetry data, as described herein. The simulation 120 can include one or more computer programs, scripts, or other executable instructions executing on a computer, such as the computing system 1100 described herein in conjunction with FIGS. 11A and 11B. In some implementations, the simulation 120 can execute on the processor of the simulator system 105. The flight autonomy system can be any type of system or subsystem that relates to autonomous flight, navigation, otherwise making operations of a vehicle autonomous, including an autopilot system, a radar system, systems that implement flight control algorithms, or other types of systems.

The simulation 120 can receive simulator parameters, such as the parameters 175, from the simulator system 105 with instructions to carry out a test case (e.g., one or more of the test cases 170, etc.). The simulation 120 can simulate real-time physical simulations of objects by providing input values to a device-under-test (such as a UAV system, etc.) according to time-step values. Time step values can specify the amount of simulated time that occurs between calculating the next state of the simulation 120. During a time step, the simulation 120 can provide inputs to a device-under-test, and can monitor and record outputs from the device-under-test in response to the previous time step. Thus, some of the time step values can correspond to input values (e.g., any type of signal, such as a sensor signal, etc.) that are generated or provided by the simulation 120 to the device-under test. The time step values, and the simulator events that should occur at each time step value, can be specified in the test cases 170 or the parameters 175. In some implementations, when starting a new test case 170, the simulator can start at time step “zero,” or the beginning of a test case 170. As the simulation 120 progresses, the simulation can increment the time step and perform all computations specified in the test case 170 (e.g., different signals to provide based on the parameters 175, etc.) to the system under test.

The simulation 120 can transmit the signals received from the device-under-test in one or more messages to the simulator system 105, which can store the signals received from the system under test as the feedback 180 in the storage 315. In some implementations, the simulation 120 can terminate upon the occurrence of a condition, such as a simulated collision or other type of failure condition, or any other type of condition, such as a particular parameter falling within a predetermined range or an occurrence of a predetermined event. Termination conditions can also include a successful termination of the simulation (e.g., a target time step reached without any failures occurring or target conditions being met, etc.). The simulation 120 can transmit the failure or success conditions, along with signals received from the device-under-test, to the simulator system 105 for inclusion in the feedback 180. The simulation 120 can communicate with the simulator system 105 via a suitable computer network or suitable communications interface (e.g., a USB interface, CAT-5 interface, serial interface, or any other type of communications interface, etc.).

The test cases 170 can be test cases that are provided to or generated by the simulator system 105, for example in response to input from the simulation 120. Test cases 170 can be instructions that cause the simulation 120 to provide input values to the system-under-test in the simulation 120 at certain time steps. In some implementations, the inputs are provided at predetermined time step intervals. Inputs can also be specified as occurring based on feedback received from the system under test. The test cases 170 can be scriptable, that is, include conditional logic or instructions to form complex test cases 170 as needs arise. The test cases 170 can each be associated with a corresponding set of parameters 175, which can specify certain characteristics of each test case 170. For example, each test case 170 can be considered a script or series of inputs that occur at predetermined (or determined as part of the simulation 120) time steps. However, the magnitude and type of each input that occurs at each time step, along with certain baseline operating conditions of the simulation 120, can be defined by the test case 170 parameters 175. The test cases 170 can be configured to dynamically respond to outputs of a system-under-test, such as a UAV control system (e.g., the flight autonomy system 320 described herein below, etc.). For example, a test case 170 can include a script or other instructions that cause a simulator (e.g., the simulator 120, etc.) to provide additional output in response to signals received from the system-under-test. In some implementations, the test cases 170 can include instructions that cause a simulator, such as the simulator 120, to vary the parameters 175 of a test case 170 in response to signals from a system-under-test.

Each of the parameters 175 can correspond to a type of signal or input that can be provided to the simulation 120. The parameters 175 can be baseline physical parameters, or can be other types of parameters 175 that define the type and magnitude of inputs provided to the system under test. Some examples of baseline parameters can include the construction of the simulated world (e.g., video input according to velocity orientation, three-dimensional models, etc.), wind speed or direction, cloud cover, location, time of day, environmental lighting conditions (e.g., amount of light, angle of sunlight, etc.), foreign objects (e.g., including location, speed, size, and properties of said foreign objects, etc.), among others. Some device specific parameters can include system-under-test acceleration, system-under-test orientation (e.g., roll, pitch, yaw, etc.), system-under-test velocity, system-under-test size or shape, system-under-test weight, or system-under-test altitude, among others. In some implementations, one or more of the parameters 175 can be specified as a range of parameters (e.g., a range of velocity values, a range of altitude values, a range of foreign object velocity values, etc.). In some implementations, one or more of the parameters 175 of a test case 170 can be analogous to data generated by, or provided from, various sensors (e.g., the position sensors 330, the cameras 325, etc.) coupled to a system-under-test. Varying the parameters 175, as part of a test case 170, for example, can cause a system-under-test to experience different sensor inputs as a simulation is executed.

A test case 170 can be repeated multiple times by the simulation 120 using different values within the range of parameters 175 for that test case 170. For example, a test case 170 can be repeated with different velocity values by selecting random values of one or more parameters specified in ranges in the parameters 175. In some implementations, the range of parameter values in the parameters 175 can be associated with a probability distribution (e.g., certain values are more likely to be selected during a test case 170 than others, etc.). In some implementations, each value in a range of parameters can have an equal probability of being selected for a particular “run” of a test case 170. Thus, the simulation 120 can run test cases 170 using repeated random sampling, similar to a Monte-Carlo simulation. Based on the feedback 180 from the simulation 120, the simulator system 105 can generate new test cases 170 with different ranges of parameters 175, as described herein.

Referring now to the operations of the simulator system 105, the simulation monitor 130 can monitor one or more inputs (e.g., such as the feedback 180, etc.) from the simulation 120 a test case 170. The simulation monitor 130 can initiate a test case 170 by transmitting the test case to the simulation 120 with instructions to begin the simulation. The test case 170 can be transmitted via a suitable computer network or any other type of suitable computer communications interface. In some implementations, the simulation 120 can be executing on the simulation system 105, and the simulation monitor 130 can transmit the test case using inter-process communication or a similar communication protocol. As the simulation progresses (e.g., the time step is incremented by the simulation 120, etc.), the simulation monitor 130 can request information about the simulation, and receive feedback 180 in response, which the simulation monitor 130 can store in the storage 115 for later processing.

The test case 170 can be selected from one of many test cases 170 in the storage 115. The test case 170 can be selected, for example, based on user input or based on an internal configuration setting. In some implementations, the test case 170 can be loaded from information that describes a real encounter, such as a real-world failure event or a predetermined (e.g., target) condition, that occurred, for example, during an aerial flight. When monitoring the simulation 120, the simulation monitor 130 can provide one or more events (e.g., or simulated conditions, etc.) of the first test case at predetermined time steps. In such a case, the simulation monitor 130 can itself execute portions of the simulation 120, and provide events (e.g., conditions or other signals, etc.) at predetermined time steps. Some example signals can include a sudden change in velocity, the appearance of a foreign object, a change in wind direction or speed, or a sudden change in device-under-test orientation (e.g., signals showing a change in telemetry data, etc.), among others. In some implementations, additional parameters can be provided to the simulation 120 at different time steps, which can be predetermined or determined based on feedback 180 that is received form the simulation 120. In some implementations, the one or more events or conditions can be provided in the form of a test case 170 in its entirety (e.g., a test case 170 script, etc.).

The simulation monitor 130 can receive feedback 180 generated by the simulation 120 in response to the one or more events (e.g., or conditions, etc.) of the first test case 170 as the input from the first simulation. Feedback 180 can include signals generated by the system under test, information about current conditions of the simulation (e.g., current time step, whether a test case 170 condition is satisfied, etc.), as well as other information about the simulation 120. A test case 170 condition can include, for example, an expected output from a device-under-test that receives an input specified in a test case 170. One such type of condition is a failure condition, in which a simulation will fail (e.g., produce a failure signal, etc.) if the simulation does not meet a condition specified in the test case 170. Another example condition can be a success condition, in which a simulation will produce a success signal if output signals from a device-under-test meet (e.g., match, or fall within specified ranges, etc.) criteria specified in the test case 170. Yet another condition may be a condition relating to an output of the simulation (e.g., an output of the flight autonomy system) falling within a predetermined range of values (which can be numerical values or values associated with particular categories associated with the condition, such as values representative of one or more particular states of an entity), or the occurrence of an event. As used herein, target conditions may encompass any type of condition, including failure conditions, conditions relating to parameters falling within predetermined ranges, occurrences of predetermined output, or any other type of predetermined simulated event or condition. As described herein, the feedback 180 can include signals about the termination of a test case 170, and can be received from the simulation 120 periodically or in batch (e.g., a portion of the feedback 180 for a test case 170 is received at predetermined intervals, upon the occurrence of a condition, or upon termination of the simulation 120, etc.).

The feedback 180 can include information about whether a successful termination condition has been met. In some implementations, the feedback 180 can be provided with an indication of a failure condition or any other type of condition being met during the simulation. In the event of a target condition being met, the feedback information 180 can include information about the test case 170 parameters 175 during the simulation. In some implementations, the feedback 180 received in the event of a target condition can identify the type of target condition, a time step during which the target condition occurred, a severity of the target condition, or parameters 175 that were changed or selected that can have caused the target condition, among others.

The condition detector 135 can detect based on the feedback 180 from the first simulation, a target condition resulting from the first test case. A target condition detected by the condition detector 135 can be any type of condition specified in the test case 170 provided to the simulation 120, or can be a universal condition (e.g., a crash or other collision, a near-collision event, a software fault, etc.). In some implementations, to detect a target condition, the condition detector 135 can monitor feedback 180 as it is received from the simulation 120, and attempt to identify an indication of a target condition (e.g., by parsing the messages in the feedback 180, etc.). In some implementations, the condition detector 135 can analyze the feedback 180 for a test case 170 once the simulation 120 has finished executing that test case 170.

In some implementations, a target condition may not be explicitly defined in the feedback 180. In such implementations, the condition detector 135 can detect the target condition from the simulation 120 of the test case 170 by determining a difference between the feedback 180 from the simulation 120 and an expected feedback value for the test case 170. In some implementations, test cases 170 can specify results or actions that must be met to successfully complete the test case 170. In the event that one or more (e.g., as specified in the test case 170, etc.) conditions or actions by the device-under-test are not met, the simulation 120 of the test case 170 can indicate that a target condition has been met. In some implementations, detecting the target condition can include comparing portions of the information in the feedback 180 to one or more success thresholds (e.g., values, acceptable ranges, etc.) specified for the simulated test case 170 that generated the feedback 180. If the feedback 180 from the test case 170 exceeds one or more (e.g., as specified in the test case, etc.) of these ranges or values, the condition detector 135 can determine that a target condition has been satisfied. A target condition can be specified as a logical condition in a test case 170. In a UAV environment, for example, a target condition may be a failure condition, such as a collision event, a near-collision event, a failure to perform a specified maneuver within a particular time step, or at least part of a flight autonomy system failing. In some implementations, a target condition can include a misdetection (e.g., misclassification, or failure to detect, false-positive detection, etc.) of another moveable object, such as an aircraft. In some implementations, a target condition can include an estimation of distance (e.g., between the flight system and an object of interest or the environment, etc.) having errors being greater exceeding a predetermined bounds. In some implementations, the condition detector 135 can determine a time step during the simulated test case 170 at which the target condition occurred by analyzing the feedback information. For example, if a certain condition was supposed to be met at a certain time step as specified in the simulated test case 170, and the condition detector 135 determines that the condition was not met (e.g., by comparing the feedback 180 to expected results for the test case 170, etc.), the condition detector 135 can determine that certain time step as the time step during which the target condition occurred. The condition detector 135 can detect more than one target condition for a simulated test case 170.

Once one or more target conditions for a test case 170 have been detected by the condition detector 135, the parameter identifier 140 can identify the parameters 170 of the test case 170 that were associated with the target condition. Identifying the parameters associated with the test case 170 can include identifying the specific values of the parameters 175 used in the simulation 120 of the test case 170. For example, if the test case 170 specifies that random values are selected from predetermined ranges of the parameters 175, the parameter identifier 140 can identify the specific values selected for use in the simulation 120 of the test case 170. In some implementations, each of the parameters 170 is associated with a priority value. For example, and not by way of limitation, the velocity of the device-under-test can have a higher priority than the altitude of the system under test. The priority of a particular parameter 175 can be specified in the test case 170 or by configuration settings associated with the parameters 170. Furthering the example above, in some implementations, the parameter identifier 140 can identify parameters having a priority above a predetermined threshold, or identify a predetermined number of parameters 175 having the highest (e.g., compared to other parameters 175, etc.) priority. In some implementations, the parameters 175 can be associated with a particular time step in a test case 170. When a time step that is specified in a test case 170 is reached in the simulation 120, the parameter identifier 140 can retrieve one or more of the parameters 175 that are associated with that time step.

In some implementations, the parameter identifier 140 can identify parameters 175 as associated with the test case 170 based on the simulation time step of the target condition. For example, based on the time step information determined by the condition detector 135, the parameter identifier 140 can determine parameters 175 of the test case 170 that are likely relevant to timing of the target condition. For example, the parameter identifier 140 can determine whether any parameters 175 were changed (e.g., as specified by the test case 170, etc.) prior to the target condition occurring. To do so, the parameter identifier 140 can access the test case 170 that resulted in the target condition, and step backwards through the time steps starting at the time step in which the target condition occurred. The parameter identifier 140 can access a predetermined range of time steps from the target condition time step. For each time step, the parameter identifier 140 can enumerate any of the parameters 175 that were changed as the test case 170 was executed by the simulation 120. Each of the enumerated parameters 175 can be identified as potentially contributing to the detected target condition, and extracted as described herein. The parameter identifier 140 can identify parameters 175 that were changed within a predetermined time period (e.g., predetermined number of time steps, etc.) prior to the target condition occurring as relevant to the target condition and to the test case 170. In some implementations, the parameter identifier 140 can identify one or more events, such as output provided by the device-under-test, which occurred prior to (e.g., a predetermined number of time steps before, etc.) the simulation time at which the target condition occurred. The parameter identifier 140 can identify parameters 175 associated with the output by the device-under-test as relevant to the test case. For example, the parameters 175 are of the first test case can include extracting the first simulation parameters based on the one or more events of the first test case.

The parameter identifier 140 can extract the parameters identified as relevant to the test case or the target condition by copying the values of the ranges associated with the identified parameters to another region of memory. In some implementations, the parameter identifier 140 can identify and extract parameters 175 that are relevant to the test case based on a combination of the factors identified above. For example, the parameter identifier 140 can identify parameters 175 that occurred within a predetermined period before an event in the simulation 120, and extract a subset of those parameters 175 that have a respective priority value that satisfies a predetermined priority threshold. For example, the predetermined period can be specified as part of the test case 170, or can be specified as an internal configuration setting. In some implementations, the predetermined period can be an amount of time associated with a decision (e.g., an orientation correction, change in altitude, a turn, or an evasive maneuver, etc.) is made by the system under test (e.g., a UAV, etc.). In some implementations, the predetermined period can be selected based on the type of target condition. For example, the test case 170 can specify different numbers of time steps preceding the target condition for different types (e.g., collision, near-collision, etc.) of detected target conditions. Thus, using the aforementioned processes, the parameter identifier 140 can identify (and extract or copy) parameters that are relevant to the test case 170, and which can have contributed to the target condition that occurred when simulating the test case 170. In some implementations, the parameter identifier 140 can identify and extract parameters from a plurality simulations, or runs, of a test case 170 that are executed with different, pseudo-randomly selected parameters. The identified parameters, and the target conditions associated with those parameters, can be stored in one or more data structures in the memory of the simulation system 105. In some implementations, the parameter identifier 140 can cause the simulation 120 to execute multiple first test cases 170, and identify various conditions for each of the executed test cases 170 or combinations of any of the multiple first test cases 170 as described herein.

Responsive to identifying and extracting parameters that are relevant to the target conditions, the test case generator 145 can generate a second test case 170 having simulation parameters 175 that are modified based on the simulation parameters identified by the parameter identifier 140. For example, the test case generator 145 can generate one or more cases by modifying the parameters identified and extracted by the parameter identifier 145. In some implementations, the test case generator 145 can create many (e.g., an estimated number based on the parameters that are relevant to the target condition, a predetermined number specified in a configuration setting, or until a predetermined number of target conditions have been detected, etc.) test cases 170 by randomly selecting parameter values in the ranges of the parameters 175 identified by the parameter identifier 140. For example, the identified parameters 175 can be associated with boundary conditions that define a maximum parameter value and a minimum parameter value for use in generating test cases 175. The test case generator 145 can generate test cases 170 by randomly selecting for each parameter within the boundary condition of each of the parameters 175. Each of the selected parameters can be used to create other test cases 170 that are variations of (e.g., by sampling values of the parameters in a Monte-Carlo fashion, etc.) of a first test case. In some implementations, one or more of the parameters values are not changed (e.g., held constant, etc.) from the first test case 170 when generating a new test case.

The test case provider 150 can provide the generated test cases to the simulation 120. Once test cases 170 are generated by the test case generator 145, they can be provided to the simulation 120 so they can be executed, as described herein above. Feedback information, including information about whether the test case was successful or resulted in a target condition, can be provided as feedback 180 to the simulator system 105 after executing the generated test cases 170, as described herein above. The test case provider 150 can provide the generated test cases 170 one at a time to the simulation 120, to generate feedback 180 information (e.g., whether a test case failed or succeeded, etc.). In some implementations, the test case provider 150 can provide a test case of the generated test cases 170 by pseudo-randomly selecting a test case to provide to the simulation 120 from the one or more generated test cases.

The test case generator 145, upon receiving the feedback 180 from the generated test cases, can associate (e.g., store, etc.) any detected conditions of the simulation 120 with each respective the test case 170 generated by the test case generator 145. Thus, the test case generator 145 can maintain a data structure that includes each generated test case 170 stored in association with whether that test case led to the occurrence of a target condition when simulated in the simulation 120. Using this information, the test case generator 145 can narrow the boundary conditions of the parameters of the test cases 170, and generate a new set of test cases 170 using the narrow boundary conditions. In some implementations, if the test case generator 145 determines that there is uncertainty about a parameter affecting the outcome (e.g., causing the target condition, etc.), the test case generator 145 can generate test cases 170 that reduce uncertainty. For example, if a parameter is known (e.g., based on previously feedback 180, etc.) to have a lower correlation with the target condition, the test case generator 145 can generate new test cases 145 that maintain other parameters and generate new test cases 170 that vary only the uncertain parameter. If the target condition occurs even when the uncertain parameter is varied across a wide range of possible values, then the test case generator 145 can determine that the uncertain parameter is unlikely to contribute to the target condition. Otherwise, the test case generator 145 can determine that the uncertain parameter does contribute to the target condition, and narrow the boundaries of the uncertain parameter as described herein.

The test case generator 145 can analyze the occurrence of target conditions across the feedback information 180 and determine certain sets, or ranges, of different parameters 175 that are more closely associated with a target condition. For example, the parameters 175 that are more closely associated with a target condition can include a predetermined number of parameters having a highest priority value. In some implementations, the parameters 175 can be predetermined, or selected based on a specified configuration setting. To do so, the test case generator 145 can scan through each of the parameters 175 of the generated test cases, and identify intervals (e.g., ranges, etc.) of test cases 170 that are associated with more failure conditions (or target conditions) than success conditions (or output that does not satisfy a target condition). In some implementations, the intervals (e.g., defined by boundary conditions, etc.) can be identified by determining boundary conditions (e.g., using a binary search algorithm, or another type of search algorithm, etc.) for intervals of parameters 175 that indicate a number of target conditions that are greater than a predetermined threshold. The intervals, or ranges, of parameter values can therefore represent more challenging test cases 170 than the superset of test cases 170 executed by the simulation 120. From the identified ranges of parameter values, the test case generator 145 can generate new sets of boundary conditions for each parameter 175 associated with the target conditions.

Using these new boundary conditions, the test case generator 145 can generate additional test cases 170 with parameters 175 within the new boundary conditions. Generating said new test cases 170 can include, for example, keeping other parameter values constant (e.g., or randomly selecting parameter values within ranges having unmodified boundary conditions, etc.), and then stochastically sampling values within the identified narrower boundary conditions. Stochastically sampling values within the narrower boundary conditions can include, for example, utilizing a pseudo-random number generator to generate a number within the narrower boundary conditions, and selecting a parameter 175 value that is associated with that pseudo-random number. In some implementations, the test case generator 145 can perform weighted or uniform sampling of values near the boundary conditions, instead of performing stochastic sampling. The test case generator 145 can therefore generate test cases 170 having parameters that are more likely to cause a target condition, as the identified ranges include occurrences of target conditions that are greater than a predetermined threshold. The test case provider 150 can then provide the test cases 170 to the simulation 120, which can produce additional feedback information. By focusing on test cases 170 that are more likely to produce target conditions, rather than simply random-sampling parameters for a broad, unfocused group of test cases 170, the simulator system 105 can more efficiently train machine-learning based devices-under-test.

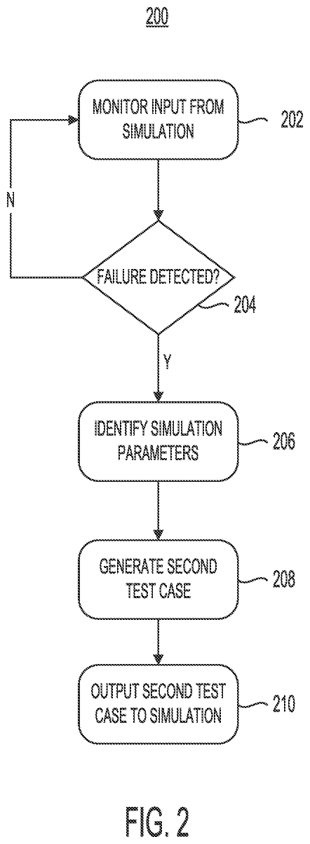

Referring now to FIG. 2, depicted is an illustrative flow diagram of a method 200 for generating test cases for a simulator based on simulated events. The method 200 can be executed, performed, or otherwise carried out by the simulator system 105, the computer system 1100 described herein in conjunction with FIGS. 11A and 11B, or any other computing devices described herein. In brief overview, at STEP 202, the simulator system (e.g., the simulator system 105, etc.) can monitor input (e.g., the feedback 180, etc.) from a simulation (e.g., the simulation 120, etc.). At STEP 204, the simulator system can determine whether a target condition has been detected. At STEP 206, the simulator system can identify simulation parameters relevant to the detected target condition. At STEP 208, the simulator system can generate a second test case. At STEP 210, the simulator system can output the second test case.

In further detail, at STEP 202, the simulator system (e.g., the simulator system 105, etc.) can monitor input (e.g., the feedback 180, etc.) from a simulation (e.g., the simulation 120, etc.) of a test case (e.g., the test case 170, etc.). The simulator system can initiate a test case by transmitting the test case to the simulation with instructions to begin the simulation. The test case can be transmitted via a suitable computer network or any other type of suitable computer communications interface. In some implementations, the simulation can be executed on the simulation system, and the simulator system can transmit the test case using inter-process communication or a similar communication protocol. As the simulation progresses (e.g., the time step is incremented by the simulation, etc.), the simulator system can request information about the simulation, and receive feedback, or input, in response, which the simulator system can store in computer memory for later processing.

The test case can be selected from one of many test cases in the memory of the simulator system (e.g., the storage 115, etc.). The test case can be selected, for example, based on user input or based on an internal configuration setting. When monitoring the simulation, the simulator system can provide one or more events of the first test case at predetermined time steps. In such a case, the simulator system can itself execute portions of the simulation, and provide events (or other signals, etc.) at predetermined time steps. Some example signals can include a sudden change in velocity, the appearance of a foreign object, a change in wind direction or speed, or a sudden change in device-under-test orientation (e.g., signals showing a change in telemetry data, etc.), among others. In some implementations, additional parameters can be provided to the simulation at different time steps, which can be predetermined or determined based on feedback that is received form the simulation. In some implementations, the one or more events can be provided in the form of a test case in its entirety (e.g., a test case script, etc.).

The simulator system can receive feedback generated by the simulation in response to the one or more events of the first test case as the input from the first simulation. In some implementations, the simulator system can run multiple simulations in parallel, and receive feedback generated by each simulation. The feedback generated by each parallel simulation can be processed individually with respect to that simulation, as described herein. Feedback can include signals generated by the system under test, information about current conditions of the simulation (e.g., current time step, whether a test case condition is satisfied, etc.), as well as other information about the simulation. A test case condition can include, for example, an expected output from a system-under-test that receives an input specified in a test case. One such type of condition is a target condition, in which a simulation will fail (e.g., produce a failure signal, etc.) if the simulation does not meet a condition specified in the test case. Another example condition can be a success condition, in which a simulation will produce a success signal if output signals from a device-under-test meet (e.g., match, or fall within specified ranges, etc.) criteria specified in the test case. Yet another condition may be a condition relating to an output of the simulation (e.g., an output of the flight autonomy system) falling within a predetermined range of values, or the occurrence of an event. As used herein, target conditions may encompass any type of condition, including failure conditions, conditions relating to parameters falling within predetermined ranges, occurrences of predetermined output, or any other type of predetermined simulated event or condition. As described herein, the feedback can include signals about the termination of a test case, and can be received from the simulation periodically or in batch (e.g., a portion of the feedback for a test case is received at predetermined intervals, upon the occurrence of a condition, or upon termination of the simulation, etc.).

At STEP 204, the simulator system can determine whether a target condition has been detected. The simulator system can detect, based on the feedback from the first simulation (e.g., the simulation being executed on a flight autonomy system as described herein, etc.), a target condition resulting from the first test case. A target condition detected by the simulator system can be any type of target condition specified in the test case provided to the simulation 120, or can be a universal condition (e.g., a crash or other collision, a near-collision event, a software fault, etc.). In some implementations, to detect a target condition, the simulator system can monitor feedback as it is received from the simulation 120, and attempt to identify an indication of a target condition (e.g., by parsing the messages in the feedback, etc.). In some implementations, the simulator system can analyze the feedback for a test case once the simulation 120 has finished executing that test case.

In some implementations, a target condition may not be explicitly defined in the feedback. In such implementations, the simulator system can detect the target condition from the simulation of the test case by determining a difference between the feedback from the simulation (e.g., the system-under-test running the simulation, etc.) and an expected feedback value for the test case. In some implementations, test cases can specify results or actions that must be met to successfully complete the test case. In the event that one or more (e.g., as specified in the test case, etc.) conditions or actions by the device-under-test are not met, the simulation of the test case can indicate that a target condition has been met. In some implementations, detecting the target condition can include comparing portions of the information in the feedback to one or more success thresholds (e.g., values, acceptable ranges, etc.) specified for the simulated test case that generated the feedback. If the feedback from the test case exceeds one or more (e.g., as specified in the test case, etc.) of these ranges or values, the simulator system can detect a target. A target condition can be specified as a logical condition in a test case. In a UAV environment, for example, a target condition can be a collision event, a near-collision event, or a failure to perform a specified maneuver within a particular time step. In some implementations, the simulator system can determine a time step during the simulated test case at which the target condition occurred by analyzing the feedback information. For example, if a certain condition was supposed to be met at a certain time step as specified in the simulated test case, and the simulator system determines that the condition was not met (e.g., by comparing the feedback to expected results for the test case, etc.), the simulator system can determine that certain time step as the time step during which the target condition occurred. The simulator system can detect more than one target condition for a simulated test case.

At STEP 206, the simulator system can identify simulation parameters relevant to the detected target condition. Once one or more target conditions for a test case have been detected by the simulator system, the simulator system can identify the parameters of the test case that were associated with the target condition. Identifying the parameters associated with the test case can include identifying the specific values of the parameters used in the simulation of the test case. For example, if the test case specifies that random values are selected from predetermined ranges of the parameters, the simulator system can identify the specific values selected for use in the simulation of the test case. In some implementations, each of the parameters is associated with a priority value. For example, and not by way of limitation, the velocity of the device-under-test can have a higher priority than the altitude of the system under test. The priority of a particular parameter can be specified in the test case or by configuration settings associated with the parameters. Furthering the example above, in some implementations, the simulator system can identify parameters having a priority above a predetermined threshold, or identify a predetermined number of parameters having the highest (e.g., compared to other parameters, etc.) priority. In some implementations, the parameters 175 can be associated with a particular time step in a test case 170. When a time step that is specified in a test case 170 is reached in the simulation 120, the parameter identifier 140 can retrieve one or more of the parameters 175 that are associated with that time step.

In some implementations, the simulator system can identify parameters as associated with the test case based on the simulation time step of the target condition. For example, based on the time step information determined by the simulator system, the simulator system can determine parameters of the test case that are likely relevant to timing of the target condition. For example, the simulator system can determine whether any parameters were changed (e.g., as specified by the test case, etc.) prior to the target condition occurring. To do so, the simulator system can access the test case that resulted in the target condition, and step backwards through the time steps starting at the time step in which the target condition occurred. The simulator system can access a predetermined range of time steps from the target condition time step. For each time step, the simulator system can enumerate any of the parameters that were changed as the test case was executed by the simulation. Each of the enumerated parameters can be identified as potentially contributing to the detected target condition, and extracted as described herein. The simulator system can identify parameters that were changed within a predetermined time period (e.g., predetermined number of time steps, etc.) prior to the target condition occurring as relevant to the target condition and to the test case. In some implementations, the simulator system can identify one or more events, such as output provided by the device-under-test, which occurred prior to (e.g., a predetermined number of time steps before, etc.) the simulation time at which the target condition occurred. The simulator system can identify parameters associated with the output by the device-under-test as relevant to the test case. For example, the parameters of the first test case can include extracting the first simulation parameters based on the one or more events of the first test case.

The simulator system can extract the parameters identified as relevant to the test case or the target condition by copying the values of the ranges associated with the identified parameters to another region of memory. In some implementations, the simulator system can identify and extract parameters that are relevant to the test case based on a combination of the factors identified above. For example, the simulator system can identify parameters that occurred within a predetermined period before an event in the simulator, and extract a subset of those parameters that have a respective priority value that satisfies a predetermined priority threshold. The predetermined period can be specified as part of the test case, or can be specified as an internal configuration setting. In some implementations, the predetermined period can be an amount of time associated with a decision (e.g., an orientation correction, change in altitude, a turn, or an evasive maneuver, etc.) that is made by the system under test (e.g., a UAV, etc.). In some implementations, the predetermined period can be specified as part of the initial state of the test case. In some implementations, the predetermined period can be selected based on the type of target condition. For example, the test case can specify different numbers of time steps preceding the target condition for different types (e.g., collision, near-collision, etc.) of detected target conditions. Thus, using the aforementioned processes, the simulator system can identify (and extract or copy) parameters that are relevant to the test case, and which can have contributed to the target condition that occurred when simulating the test case. In some implementations, the simulator system can identify and extract parameters from a plurality simulations, or runs, of a test case that are executed with different, pseudo-randomly selected parameters. The identified parameters, and the target conditions associated with those parameters, can be stored in one or more data structures in the memory of the simulation system. In some implementations, the simulator system can cause the simulation to execute multiple first test cases, and identify target conditions for each of the executed test cases 170 as described herein.

At STEP 208, the simulator system can generate a second test case. The simulator system can generate a second test case having simulation parameters that are modified based on the simulation parameters identified by the parameter identifier 140. For example, the simulator system can generate one or more cases by modifying the parameters identified and extracted by the parameter identifier 140. In some implementations, the simulator system can create many (e.g., a predetermined number specified in a configuration setting, or until a predetermined number of target conditions have been detected, etc.) test cases by randomly selecting parameter values in the ranges of the parameters identified by the parameter identifier 140. For example, the identified parameters can be associated with boundary conditions that define a maximum parameter value and a minimum parameter value for use in generating test cases. The simulator system can generate test cases by randomly selecting for each parameter within the boundary condition of each of the parameters. Each of the selected parameters can be used to create other test cases that are variations of (e.g., by randomly selecting values of the parameters) of a first test case. In some implementations, one or more of the parameters values are not changed (e.g., held constant, etc.) from the first test case when generating a new test case.

The simulator system can provide the generated test cases to the simulator. Once test cases are generated by the simulator system, they can be provided to the simulation so they can be executed, as described herein above. Feedback information, including information about whether the test case was successful or resulted in a target condition, can be provided as feedback to the simulator system 105 after executing the generated test cases, as described herein above. The simulator system can provide the generated test cases one at a time to the simulator, to generate feedback information (e.g., whether a test case failed or succeeded, etc.). In some implementations, the simulator system can provide a test case of the generated test cases by pseudo-randomly selecting a test case to provide to the simulator from the one or more generated test cases.

The simulator system, upon receiving the feedback from the generated test cases, can associate (e.g., store, etc.) any conditions (e.g., success, failure, other conditions, etc.) of the simulator with each respective test case generated by the simulator system. Thus, the simulator system can maintain a data structure that includes each generated test case stored in association with whether that test case led to a target condition when tested by the system under test. Using this information, the simulator system can narrow the boundary conditions of the parameters of the test cases, and generate a new set of test cases using the narrow boundary conditions. In certain cases the simulator can increase the sampling size and/or apply a weighted sampling strategy that focuses on accurately finding the condition boundaries. The simulator system can analyze the occurrence of target conditions across the feedback information and determine certain sets, or ranges, of different parameters that are more closely associated with a target condition. For example, the parameters that are more closely associated with a target condition can include a predetermined number of parameters having a highest priority value. In some implementations, the parameters can be predetermined, or selected based on a specified configuration setting. To do so, the simulator system can scan through each of the parameters of the generated test cases, and identify intervals (e.g., ranges, etc.) of cases that are associated with more failure conditions (or target conditions) than success conditions (or output that does not satisfy a target condition). In some implementations, the intervals (e.g., defined by boundary conditions, etc.) can be identified by determining boundary conditions (e.g., using a binary search algorithm, or another type of search algorithm, etc.) for intervals of parameters that indicate a number of target conditions that are greater than a predetermined threshold. The intervals, or ranges, of parameter values can therefore represent more challenging test cases than the superset of test cases executed by the simulation. From the identified ranges of parameter values, the simulator system can generate new sets of boundary conditions for each parameter associated with the target conditions.

At STEP 210, the simulator system can output the second test case. The simulator system can transmit the test cases having parameters selected from narrower ranges over a communication interface, such as a computer network or another type of communications bus. In some implementations, the simulator system can provide test cases one at a time, waiting for the simulator to complete a test case (e.g., provide a simulation termination signal, etc.) before providing another test case. The test cases can be pseudo-randomly selected, for example, or in some implementations, provided to the simulator in the order that the test cases were generated.

B. Evaluating Real-Time Output from a Simulator for Flight Autonomy Systems

Simulators of extreme high-fidelity are generally required for development, training, and testing of autonomous systems. Fidelity and synchronicity must be consistent across different types of signals that simulate the conditions of a real environment. Conventional solutions focus on the fidelity of the situation being represented (e.g., the locations and type of each element in the simulation, etc.). The techniques described herein can provide high fidelity visual simulation by capturing real-world properties. We use photogrammetry for capturing the visual properties of real environments, IMUs, GPS, and radars for capturing flight paths and attitudes. These assets are used as data points that are provided to a simulator for virtual environment testing. The simulators described herein can include sensor information being fed to the autonomous system being trained and tested (e.g., the device-under-test, etc.), and a platform that moves following simulated motion instructions. All the information provided allows for hardware in the loop testing and training of autonomous systems. The simulator can be connected with a flight autonomy system which is continuously evaluated for performance against the test cases executed by the simulator. The flight autonomy system can be any type of system or subsystem that relates to autonomous flight or autonomous navigation of any vehicle, including an autopilot system, a radar system, systems that implement flight control algorithms, or other types of systems.

Referring now to FIG. 3, illustrated is a block diagram of an example system 300 for evaluating real-time output from a simulator for flight autonomy systems, in accordance with one or more implementations. The system 300 can include at least one flight simulator system 305, and at least one flight autonomy system 320. The flight simulator system 305 can include at least one simulated input transmitter 340, at least one response signal receiver 345, at least one test case generator 350, at least one second test case communicator 355, and at least one storage 315. The storage 315 can include one or more test cases 170A-170N (sometimes referred to generally as test case(s) 170), one or more parameters 175A-175N (sometimes referred to generally as parameters(s) 175), and feedback 180 information. The flight autonomy system 320 can include one or more cameras 325, one or more position sensors 330 (e.g., gyroscopes, accelerometers, magnetometers, inertial measurement units (IMUs), GPS/GNSS receivers, motion sensors, etc.), and a controller 335. In some implementations, the flight simulator system 305 and the flight autonomy system 320 can be considered part of the simulation 120, as described herein above in connection with FIG. 1. In such implementations, the simulation 120 can include any software or hardware components that can provide simulated input to and receive feedback from the flight autonomy system 320. For example, the simulation 120 can utilize the flight simulator system 305 to execute one or more test cases generated by the test case generator 350 or the simulator system 105, as described herein. Any feedback generated as a result of the test cases 370 can be directed to an appropriate computing system or database, such as the database 115, the database 315, or the simulator system 105.

Each of the components (e.g., the flight simulator system 305, the flight autonomy system 320, etc.) of the system 100 can be implemented using the hardware components or a combination of software with the hardware components of a computing system (e.g., computing system 1100, any other computing system described herein, etc.) detailed herein in conjunction with FIGS. 11A and 11B. Each of the components of the flight simulator system 305 (e.g., the simulated input transmitter 340, the response signal receiver 345, the test case generator 350, the test case communicator 355, etc.), and each of the components of the flight autonomy system 320 (e.g., the cameras 325, the position sensors 330, the controller 335, etc.) can perform the functionalities detailed herein. It should be understood that the flight simulator system 305 depicted in FIG. 3 can perform all of the functionality of the simulator system 105 depicted in FIG. 1, the flight path system 605 depicted in FIG. 6, and the turbulence modeling system 805 depicted in FIG. 8. The flight autonomy system 320 can be any type of system or subsystem that relates to autonomous flight or autonomous navigation of any vehicle, including an autopilot system, a radar system, systems that implement flight control algorithms, or other types of systems.

The flight simulator system 305 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), a GPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The flight simulator system 305 can include one or more computing devices or servers that can perform various functions as described herein. The flight simulator system 305 can include any or all of the components and perform any or all of the functions of the computer system 1100 described herein in conjunction with FIGS. 11A and 11B.

The storage 315 can be a database configured to store and/or maintain any of the information described herein. The storage 315 can maintain one or more data structures, which can contain, index, or otherwise store each of the values, pluralities, sets, variables, vectors, or thresholds described herein. The storage 315 can be accessed using one or more memory addresses, index values, or identifiers of any item, structure, or region maintained in the storage 315. The storage 315 can be accessed by the components of the flight simulator system 305, or any other computing device described herein, via a network or other suitable communications interface. In some implementations, the storage 315 can be internal to the flight simulator system 305. In some implementations, the storage 315 can exist external to the flight simulator system 305, and can be accessed via a network or other suitable communications interface. In some implementations, the storage 315 can be distributed across many different computer systems or storage elements. The flight simulator system 305 can store, in one or more regions of the memory of the flight simulator system 305, or in the storage 315, the results of any or all computations, determinations, selections, identifications, generations, constructions, or calculations in one or more data structures indexed or identified with appropriate values. Any or all values stored in the storage 315 can be accessed by any computing device described herein, such as the flight simulator system 305, to perform any of the functionalities or functions described herein.

The test cases 370 can be similar to the test cases 170 described herein above in conjunction with FIG. 1. For example, test cases 170 can be instructions that cause the flight simulator system 305 to provide input values (e.g., based on the parameters 375, etc.) to the flight autonomy system 320 at certain time steps. In some implementations, the input values in the test cases 370 can correspond to inputs that would be received from the cameras 325 or the position sensors 330. For example, the motion sensors 330 may include an inertial measurement unit (IMU) that can communicate information about the velocity, acceleration, and orientation of the flight autonomy system 320 to the controller 335. The test cases 370 can include instructions that cause the flight simulator system 305 to provide signals that mimic those that are provided by the cameras 325 or the position sensors 330, but instead represent simulated values for a virtual test flight. In some implementations, the test cases 370 can include instructions that provide signals, such as virtual movement signals, or video input from a screen, to the position sensors 330 and the cameras 325, respectively.

In some implementations, the inputs in the test cases 370 can be provided at predetermined time step intervals. Inputs can also be specified as occurring based on feedback received from the flight autonomy system 320 (e.g., from the controller 335, the cameras 325, the position sensors 330, etc.). The test cases 370 can include configurable instructions, such as conditional logic to form complex test cases as needed. The test cases 370 can each be associated with a corresponding set of parameters 375, which can specify certain input characteristics of each test case 370. For example, each test case 370 can include a series of inputs that occur at predetermined (or determined as part of the simulation 120) time steps. However, the magnitude and type of each input that occurs at each time step, along with certain baseline operating conditions of a simulation provided to the flight autonomy system 320, can be defined by the parameters 375 of the test case 370.

The test cases 370 can include expected results for each of the series of inputs to the flight autonomy system 320. For example, a given test case 370 may have evaluation criteria, or conditions, that must be met to satisfy (e.g., pass, etc.) the test case. Each of the criteria, for example, can correspond to certain outputs expected from the flight autonomy system 320 within predetermined time steps. For example, after providing a certain input signal to the flight autonomy system 320, the test case may expect a corresponding response from the flight autonomy system 320 within a predetermined number of time steps. In another example, a test case 370 may expect periodic outputs from the flight autonomy system 320, (e.g., a heartbeat signal, periodic sensor reading signals, etc.). The expected output values associated with each test case can be used by the flight simulator system 305 to evaluate the performance of the flight autonomy system 320 for any given test case 370. One performance metric evaluated by the flight simulator system 305 can include an amount by which the flight autonomy system 320 maintains safe distances from environmental objects. For example, the performance of a simulation can be evaluated by determining that the flight autonomy system 320 maintains a safe (e.g., predetermined, specified by a test case 370, etc.) distance from terrain, foreign objects, or other potentially hazardous locations (e.g., as specified by the test cases, etc.).

The parameters 375 can be similar to the parameters 175 described herein above in conjunction with FIG. 1. Each of the parameters 375 can correspond to a type of signal or input that can be provided to the flight autonomy system 320. The parameters 375 can specify the location and magnitude of inputs provided to the flight autonomy system 320. For example, the parameters 375 can include simulated IMU inputs for the position sensors 330, simulated video inputs for the cameras 325, or other simulated movement information (e.g., signals provided to a moving platform to physically move the flight autonomy system 320, etc.). In some implementations, one or more of the parameters 175 can be specified as a range of parameters (e.g., a range of IMU values for different time steps, etc.).

The flight autonomy system 320 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), a GPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The flight autonomy system 320 can include any or all of the components and perform any or all of the functions of the computer system 1100 described herein in conjunction with FIGS. 11A and 11B.

The cameras 325 can include one or more cameras capable of capturing images or video, and storing those images or videos in the memory of the flight autonomy system 320. In some implementations, the images and videos can be processed online, without long-term storage. In some implementations, the cameras 325 can provide the images or videos to the controller 335, which can analyze the images and generate movement signals for the flight autonomy system 320. In some implementations, the controller 335 can include or otherwise communicate with one or more of the cameras 335, and can stitch or merge images to form a single image. In some implementations, the flight autonomy system 320 can include or otherwise communicate with two, three, four, five, six or more than six cameras 325. The multiple cameras 325 may be configured or arranged to capture images that can be stitched or merged together to form a 360 degree field of view. As used herein, an image is not limited to an image from a single camera, but rather, can include images captured from multiple cameras but stitched or merged together to form a single image. In some implementations, the cameras 335 can be simulated through standard inputs (e.g., a video input stream provided via a camera communications interface, serial ports, Ethernet, etc.), and transmitted to the system under test.

The controller 335 can include an auto-pilot module configured to autonomously control the flight autonomy system 320. The controller 335 can receive instructions, for example, from the flight simulator system 305, which when executed by the controller 335, can cause the flight autonomy system 320 to generate one or more signals to devices that control the speed, direction, or trajectory of the flight autonomy system 320. Such devices can include, for example, engines, throttles, rotors, propellers, flight control surfaces (e.g., fins, ailerons, slats, rudders), or other aerodynamic elements. In a testing or simulation environment, the controller 335 can transmit such signals to the flight simulator system 305 as part of the feedback 180. In some implementations, the signals can be transmitted to the flight simulator system 305 in conjunction with one or more timestamps, or an identifier of a time step of a simulation. The controller 335 can communicate with the position sensors 330 to receive information about the position, orientation, acceleration, or velocity of the flight autonomy system 320.

The position sensors 330 can capture and store motion data about the flight autonomy system 320. The position sensors 330 can be positioned at various locations on flight autonomy system 320, for example, to capture motion information for different parts of the flight autonomy system 320. In some implementations, the position sensor 330 can transmit signals about the motion of the flight autonomy system 320, the flight simulator system 305, or to the controller 335.

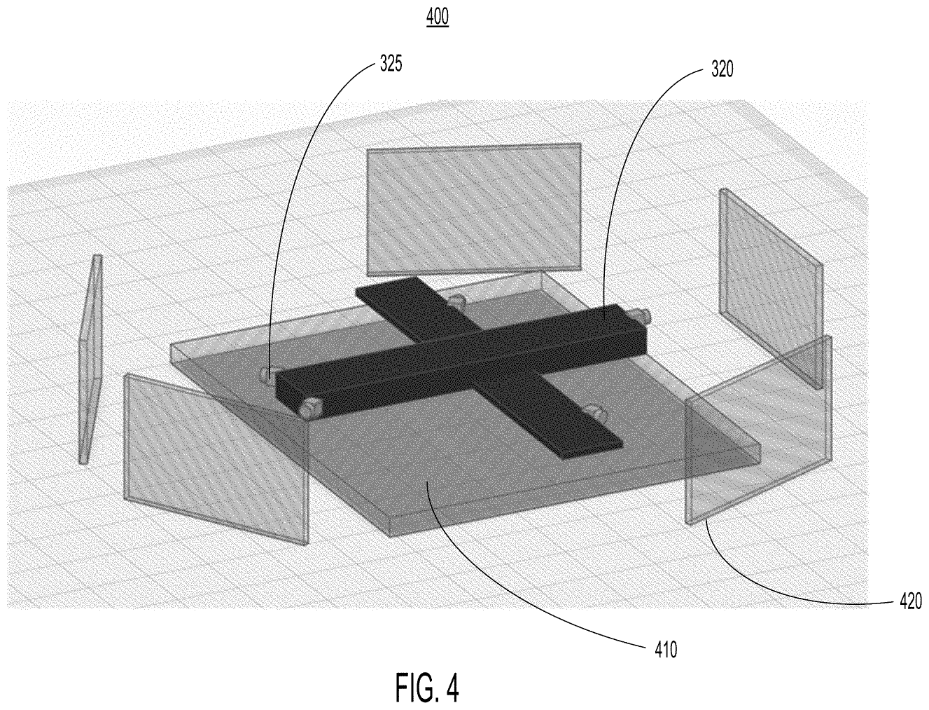

Referring briefly now to FIG. 4, depicted is a view 400 of an example flight autonomy system 320 in an example simulation environment. As shown, the flight autonomy system 320 is positioned on a platform 410. The platform 410 can include one or more motors (e.g., engines), and can rotate along one or more of its axes (e.g., roll, pitch, yaw axes). The platform 410 can also vibrate at different controllable frequencies. As the platform 410 rotates, the flight autonomy system 320 can experience a change in orientation. The magnitude and direction of the platform 410 rotates of the platform can be governed, for example, by the flight simulator system 305. The platform 410 (e.g., the actuators for the platform 410, etc.), can receive signals from the flight simulator system 305 that cause the platform to rotate according to one or more test cases 370 or parameters 375. For example, the test cases 370 can include instructions that cause the platform to rotate based on certain ones of the parameters 375, such as wind speed, simulated turbulence, or other motion based events, such as signals to change the orientation of the simulated UAV received from the flight autonomy system 320. As shown, the cameras 325 are positioned on various locations on the aerial vehicle to which the flight autonomy system 320 is mounted, and a corresponding simulation screen 420 is positioned to face the cameras 325. In some implementations, the cameras 325 can form a part of the flight autonomy system. The simulation screens 420 can receive signals from the flight simulator system 305, and can display videos or images to each of the cameras 325, thereby providing the flight autonomy system 320 with video input.

Referring back now to FIG. 3, and to the functionality of the flight simulator system 305, the simulated input transmitter 340 can transmit simulated input of at least one test case 370 to the flight autonomy system 320. As described herein above, test case 370 can be associated with various within a first parameter range. The simulated input can include one or more events, such as changes in wind speed, changes in velocity, changes in orientation, changes in video input, or any other type of signal or input that can be received by the flight autonomy system 320. In some implementations, the simulated input transmitted can transmit inputs from a selected test case 370 at predetermined simulation time steps. The predetermined simulation time steps can be specified in the test case 370. In some implementations, the inputs can be provided at time steps that are determined during the simulation (e.g., a random time step, a time step a predetermined interval from another event or output from the flight autonomy system 320, etc.).

The simulated input transmitter 340 can generate and provide simulated video data based on simulation parameters 375 test cases 370. Generating the video data can include retrieving a video feed from a previous, real-world aerial flight to the flight autonomy system 320. In some implementations, the video data can be generated by rendering a three-dimensional (3D) environment using assets retrieved from memory of the flight simulator system 305. In some implementations, the assets can include 3D representations of real-world objects, terrains, clouds, and other assets relevant for an aerial flight. Video information can be generated, for example, as an input for each of the cameras 325 (or video inputs in implementations where cameras 325 are simulated) on the flight autonomy system 320. Information about what assets to display can correspond to telemetry data provided by the flight autonomy system 320 and the test case 370. For example, if the test case 370 provides input that the flight autonomy system 320 will be rotating in the simulation at particular time steps, the simulated input transmitter 340 can perform a rotation transform on the video feed that causes the video to correspond to the simulated rotation of flight autonomy system 320. A simulated rotation can be indicated by changes in telemetry data, as described herein below.

After generating the video data, the simulated input transmitter 340 can transmit the simulated video data to a video input of the flight autonomy system 320. The video input can be, for example, an input that receives camera data. However, instead of being attached to a camera, the generated video signals from the simulated input transmitter 340 are provided as a simulated camera input. In some implementations, the video input can be a monitor that is positioned in front of the one or more cameras 325 of the flight autonomy system 320. Such an arrangement is depicted in FIG. 4.

In some implementations, the simulated input transmitter 340 can generate telemetry data including at least one of location information (e.g., positions such as global positioning system (GPS) coordinates, velocity information, altitude information, acceleration information, or orientation information (e.g., roll, pitch, yaw, etc.). Information about the changes in telemetry data can be retrieved from a test case 370 being used in a simulation. For example, the simulated input transmitter accesses the test case 370 to retrieve predetermined changes of telemetry data (e.g., change in position, rotation, etc.) for particular time steps, and can generate input values that correspond to each motion sensor positioned on the flight autonomy system 320. In some implementations, changes in the telemetry data can be generated in response to feedback 180 received from the flight autonomy system 320. In response to simulated inputs (e.g., test case 370 input values, etc.), the flight autonomy system 320 can generate feedback 180 information, such as signals to change the position, orientation, or speed of the flight autonomy system 320. When the feedback is received, the simulated input transmitter 340 can make corresponding changes to the telemetry data. If the flight autonomy system 320 provides signals that indicate a change in rotation of the flight autonomy system 320, the simulated input transmitter 340 can generate gyroscope and accelerometer values that correspond to the signaled change in rotation.

After generating the telemetry data, the simulated input transmitter 340 can transmit the telemetry data to a telemetry input of the flight autonomy system 320. Telemetry inputs on the flight autonomy system 320 can correspond to each of the position sensors 330. As described herein above, each of the position sensors 330 can have a different type, and the flight simulator system 305 can be in communication with each of the position sensors 330. The simulated input transmitter 340 can transmit, via a network or a suitable communications interface, the generated telemetry values to appropriate ones of the flight autonomy system 320. In some implementations, the simulated input transmitter 340 can generate simulated outputs of the position sensors 330, and provide those outputs directly to the flight autonomy controller 320 during the simulation of a test case 370. In some implementations, the simulated input transmitter 340 can transmit signals to actuators positioned beneath a platform, such as the platform 410 described herein in conjunction with FIG. 4, to cause the platform to move the flight autonomy system 320 in accordance with the telemetry data.

Responsive to the simulation of a test case 370 and the simulated input transmitter 340 providing inputs based on a test case 370, the response signal receiver 345 can receive response signals generated by the flight autonomy system 340 in response to the input from the test case 370. The response signal receiver 345 can monitor outputs from the flight autonomy system 320, such as outputs from the controller 335 (e.g., outputs that would cause a real-world flight autonomy system 320 to move, etc.), or other outputs or responses generated by the flight autonomy system 320. The response signals received by the response signal receiver 345 can be similar to the feedback information 180 described herein above in conjunction with FIG. 1. When received, the response signal receiver 345 can store the signals from the flight autonomy system 320 as the feedback 380. In some implementations, the response signal receiver 345 can store the feedback 380 in association with one or more timestamps or time steps. In some implementations, the response signal receiver 345 can store the feedback 380 in association with an input that caused the flight autonomy system 320 to generate the feedback information.

The test case evaluator 355 can evaluate the feedback 380 received from the flight autonomy system 320 against expected response values of the test case 370. As described herein above, a given test case 370 may have evaluation criteria, or conditions, that must be met to satisfy (e.g., pass, etc.) the test case. Each of the criteria, for example, can correspond to certain outputs expected from the flight autonomy system 320 within predetermined time steps. For example, after providing a certain input signal to the flight autonomy system 320, the test case 370 may expect a corresponding response from the flight autonomy system 320 within a predetermined number of time steps. In another example, a test case 370 may expect periodic outputs from the flight autonomy system 320, (e.g., a heartbeat signal, periodic sensor reading signals, etc.).

The test case evaluator 355 can compare the feedback 380 received from flight autonomy system 320 to determine if the feedback matches the expected output of the test case 370 (e.g., the output is within predetermined time steps or output ranges, etc.). In some implementations, the test case evaluator 355 can evaluate the feedback 380 in a time step fashion (e.g., providing simulated input for a time step, waiting for the response signals to be generated by the flight autonomy system 320 for that time step, and then evaluating the response for that time step prior to simulating the subsequent time step, etc.). If the test case evaluator 355 determines that an expected condition is not met or the feedback 380 does not match an expected output within tolerance ranges, the test case evaluator 355 can store the test case 370 in association with a target condition. The target condition can include information about the parameters 375 of the test case 370, and can include information about which condition which condition, or output, failed to meet the requirements specified in the test case 370. In contrast, if the test case evaluator 355 determines that the response signals satisfy all of the expected outputs or conditions, or that a success condition specified in the test case 370 has been reached, the test case evaluator 355 can store a success indicator with the feedback 380 for the test case 370.

In some implementations, the test case evaluator 355 may receive too much feedback 380 to process in real-time. This may occur, for example, when certain processing resources (e.g., computing threads, system memory, etc.) are exhausted by other feedback 380 or other system functions (e.g., generating the simulated input to the flight autonomy system 320, etc.). The test case evaluator 355 can monitor the computing resources of the flight simulator system 305, the feedback 380, and the amount of simulated input that needs to be provided to the light autonomy system. The test case evaluator 355 can compare the amount of processing jobs that are needed to be completed to the total amount of available system resources, and can determine whether the flight autonomy system 320 can simulate in real-time, without delays. If the processing jobs can be managed without delays (e.g., the number of processing jobs is less than a predetermined threshold, etc.), the flight simulator system 305 can execute normally. However, if the processing jobs cannot be managed without delays, the test case evaluator 355 can generate a delay signal to the flight autonomy system 320.

In a delay circumstance, the test case evaluator 355 can generate and transmit a time control signal to the flight autonomy system 320. The delay signal can be a signal to a “suspend” input of the controller 335 of the flight autonomy system 320 that causes the flight autonomy system 320 to pause, or temporarily stop, generating outputs or processing inputs from the flight simulator system 305. The delay signal can be generated for a predetermined time period. In some implementations, the delay signal can be generated and transmitted until a processing condition is reached (e.g., all processing jobs are complete, etc.). By using a delay signal to halt the flight autonomy system 320 while the flight simulator system 305 generates outputs, the flight autonomy system 320 can process the input signals from the simulator seamlessly, as if the flight autonomy system 320 were receiving those signals in real-time. Without a delay signal, the flight autonomy system 320 would continue to process input that might be delayed, interfering with the overall fidelity of the simulator.

The test case generator 350 can be similar to the test case generator 145, and can generate second test cases based on the response signals received from the flight autonomy system 320. For example, the test case generator 350 can access feedback 380 from historic simulation data stored in the storage 335 for test cases having ranges of different values. As described herein above, the test cases 370 can correspond to parameters 375 that are selected from predetermined ranges defined by boundary conditions, or maximum and minimum parameter values. To generate focused test cases 370, the test case generator 350 can scan through each of the parameters in the feedback information 380 for the test cases 370, and identify intervals (e.g., ranges, etc.) of parameter values in the feedback information 380 that are associated with more target conditions than success conditions. Said another way, the test case generator 350 can identify narrower boundary conditions for certain parameters that resulted in a number of target conditions that satisfies a threshold. From the ranges of parameter values, the test case generator 145 can generate new sets of boundary conditions for each difficult interval of cases. The new boundary conditions can be the maximum and minimum parameter range values identified for ranges of parameter values that resulted in the threshold-satisfying number of target conditions.

Using these new boundary conditions, the test case generator 345 can generate additional test cases 370 with parameters within the parameter ranges defined by the new boundary conditions. Generating said new test cases can include, for example, keeping other parameter values constant (e.g., or randomly selecting parameter values within ranges having unmodified boundary conditions, etc.), and then pseudo-randomly sampling values within the identified narrower boundary conditions. The test case generator 350 can therefore generate test cases having parameters that are more likely to cause a target condition, as the identified ranges include occurrences of target conditions that are greater than a predetermined threshold. The test case generator 345 can generate these new test cases 370 with narrower parameters in response to detecting a target condition when simulating a test case 370.

After generating the new test cases 370, the simulated input transmitter 340 can transmit simulated inputs to the flight autonomy system 320 in accordance with a generated test case, as described herein above. The test case evaluator 355 can continuously evaluate the response signals from the generated test cases by comparing the response signals (e.g., the feedback 380, etc.) to expected output values in the generated test cases 370. The simulated input transmitter 340, in conjunction with the response signal receiver and the test case evaluator 355, can continuously simulate different test cases within different parameter ranges, as described herein above.

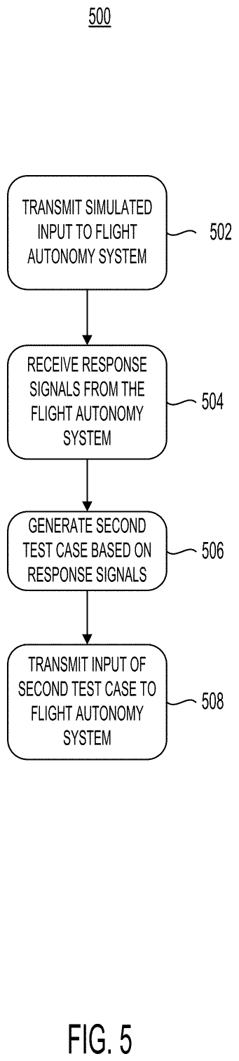

Referring now to FIG. 5, depicted is an illustrative flow diagram of a method 500 for evaluating real-time output from a simulator for flight autonomy systems. The method 500 can be executed, performed, or otherwise carried out by the flight simulator system 305, the computer system 1100 described herein in conjunction with FIGS. 11A and 11B, or any other computing devices described herein. In brief overview, at STEP 502, the flight simulator system (e.g., the flight simulator system 305, etc.) can transmit simulated input to a flight autonomy system (e.g., the flight autonomy system 320, etc.). At STEP 504, the flight simulator system can receive response signals from the flight autonomy system. At STEP 506, the flight simulator system can generate a second test case based on the response signals. At STEP 508, the flight simulator system can transmit input of the second test case to the flight autonomy system.

At STEP 502, the flight simulator system (e.g., the flight simulator system, etc.) can transmit simulated input to a flight autonomy system (e.g., the flight autonomy system 320, etc.). As described herein above, test cases can be associated with various within a first parameter range. The simulated input can include one or more events, such as changes in wind speed, changes in velocity, changes in orientation, changes in video input, or any other type of signal or input that can be received by the flight autonomy system. In some implementations, the simulated input transmitted can transmit inputs from a selected test case at predetermined simulation time steps. The predetermined simulation time steps can be specified in the test case. In some implementations, the inputs can be provided at time steps that are determined during the simulation (e.g., a random time step, a time step, a predetermined interval from another event or output from the flight autonomy system, etc.).

The flight simulator system can generate and provide simulated video data based on simulation parameters 375 test cases. Generating the video data can input retrieving a video feed from a previous, real-world aerial flight to the flight autonomy system. In some implementations, the video data can be generated by rendering a three-dimensional (3D) environment using assets retrieved from memory of the flight simulator system. In some implementations, the assets can include 3D representations of real-world objects, terrains, clouds, and other assets relevant for an aerial flight. Video information can be generated, for example, as an input for each of the cameras 325 (or video inputs in implementations where cameras 325 are simulated) on the flight autonomy system. Information about what assets to display can correspond to telemetry data provided by the flight autonomy system and the test case. For example, if the test case provides input that the flight autonomy system will be rotating in the simulation at particular time steps, the flight simulator system can perform a rotation transform on the video feed that causes the video to correspond to the simulated rotation of flight autonomy system. A simulated rotation can be indicated by changes in telemetry data, as described herein below.

After generating the video data, the flight simulator system can transmit the simulated video data to a video input of the flight autonomy system. The video input can be, for example, an input that receives camera data. However, instead of being attached to a camera, the generated video signals from the flight simulator system are provided as a simulated camera input. In some implementations, the video input can be a monitor that is positioned in front of the one or more cameras (e.g., the cameras 325, etc.) of the flight autonomy system. Such an arrangement is depicted in FIG. 4.

In some implementations, the flight simulator system can generate telemetry data including at least one of location information (e.g., positions such as global positioning system (GPS) coordinates, velocity information, altitude information, acceleration information, or orientation information (e.g., roll, pitch, yaw, etc.). Information about the changes in telemetry data can be retrieved from a test case being used in a simulation. For example, the flight simulator system accesses the test case to retrieve predetermined changes of telemetry data (e.g., change in position, rotation, etc.) for particular time steps, and can generate input values that correspond to each motion sensor positioned on the flight autonomy system. In some implementations, changes in the telemetry data can be generated in response to feedback 180 received from the flight autonomy system. In response to simulated inputs (e.g., test case input values, etc.), the flight autonomy system can generate feedback 180 information, such as signals to change the position, orientation, or speed of the flight autonomy system. When the feedback is received, the flight simulator system can make corresponding changes to the telemetry data. If the flight autonomy system provides signals that indicate a change in rotation of the flight autonomy system, the flight simulator system can generate gyroscope and accelerometer values that correspond to the signaled change in rotation.

After generating the telemetry data, the flight simulator system can transmit the telemetry data to a telemetry input of the flight autonomy system. Telemetry inputs on the flight autonomy system can correspond to position sensors (e.g., the position sensors 330, etc.) positioned on the flight autonomy system. As described herein above, each of the position sensors can have a different type (e.g., IMU, accelerometer, gyroscope, etc.), and the flight simulator system can be in communication with each of the position sensors. The flight simulator system can transmit, via a network or a suitable communications interface, the generated telemetry values to appropriate ones of the flight autonomy system. In some implementations, the flight simulator system can generate simulated outputs of the position sensors, and provide those outputs directly to the flight autonomy controller during the simulation of a test case. In some implementations, the flight simulator system can transmit signals to actuators positioned beneath a platform, such as the platform 410 described herein in conjunction with FIG. 4, to cause the platform to move the flight autonomy system in accordance with the telemetry data.

At STEP 504, the flight simulator system can receive response signals from the flight autonomy system in response to the simulated input. The flight simulator system can monitor outputs from the flight autonomy system, such as outputs from the controller 335 (e.g., outputs that would cause a real-world flight autonomy system to move, etc.), or other outputs or responses generated by the flight autonomy system. The response signals received by the flight simulator system can be similar to the feedback information 180 described herein above in conjunction with FIG. 1. When received, the flight simulator system can store the signals from the flight autonomy system as the feedback information (e.g., the feedback). In some implementations, the flight simulator system can store the feedback in association with one or more timestamps or time steps. In some implementations, the flight simulator system can store the feedback in association with an input that causes the flight autonomy system to generate the feedback information.

The flight simulator system can evaluate the feedback received from the flight autonomy system against expected response values of the test case. As described herein above, a given test case may have evaluation criteria, or conditions, that must be met to satisfy (e.g., pass, etc.) the test case. Each of the criteria, for example, can correspond to certain outputs expected from the flight autonomy system within predetermined time steps. For example, after providing a certain input signal to the flight autonomy system, the test case may expect a corresponding response from the flight autonomy system within a predetermined number of time steps. In another example, a test case may expect periodic outputs from the flight autonomy system, (e.g., a heartbeat signal, periodic sensor reading signals, etc.).

The flight simulator system can compare the feedback received from the flight autonomy system to determine if the feedback matches the expected output of the test case (e.g., the output is within predetermined time steps or output ranges, etc.). In some implementations, the flight simulator system can evaluate the feedback in a time step fashion (e.g., providing simulated input for a time step, waiting for the response signals to be generated by the flight autonomy system for that time step, and then evaluating the response for that time step prior to simulating the subsequent time step, etc.). If the flight simulator system determines that an expected condition is not met or the feedback does not match an expected output within tolerance ranges, the flight simulator system can store the test case in association with a target condition. The target condition can include information about the parameters of the test case, and can include information about which condition which condition, or output, failed to meet the requirements specified in the test case. In contrast, if the flight simulator system determines that the response signals satisfy all of the expected outputs or conditions, or that a success condition specified in the test case has been reached, the flight simulator system can store a success indicator with the feedback for the test case.

In some implementations, the flight simulator system may receive too much feedback to process in real-time. This may occur, for example, when certain processing resources (e.g., computing threads, system memory, etc.) are exhausted by other feedback or other system functions (e.g., generating the simulated input to the flight autonomy system, etc.). The flight simulator system can monitor the computing resources of the flight simulator system 305, the feedback, and the amount of simulated input that needs to be provided to the light autonomy system. The flight simulator system can compare the amount of processing jobs that are needed to be completed to the total amount of available system resources, and can determine whether the flight autonomy system 320 can simulate in real-time, without delays. If the processing jobs can be managed without delays (e.g., the number of processing jobs is less than a predetermined threshold, etc.), the flight simulator system 305 can execute normally. However, if the processing jobs cannot be managed without delays, the flight simulator system can generate a delay signal to the flight autonomy system.

In a delay circumstance, the flight simulator system can generate and transmit a time control signal to the flight autonomy system. The delay signal can be a signal to a “suspend” input of the controller of the flight autonomy system that causes the flight autonomy system to pause, or temporarily stop, generating outputs or processing inputs from the flight simulator system. The delay signal can be generated for a predetermined time period. In some implementations, the delay signal can be generated and transmitted until a processing condition is reached (e.g., all processing jobs are complete, etc.). By using a delay signal to halt the flight autonomy system while the flight simulator system generates outputs, the flight autonomy system can process the input signals from the simulator seamlessly, as if the flight autonomy system were receiving those signals in real-time. Without a delay signal, the flight autonomy system would continue to process input that might be delayed, interfering with the overall fidelity of the simulator.

At STEP 506, the flight simulator system can generate a second test case based on the response signals. The flight simulator system can access feedback 380 from historic simulation data stored in the storage 335 for test cases having ranges of different values. As described herein above, the test cases can correspond to parameters that are selected from predetermined ranges defined by boundary conditions, or maximum and minimum parameter values. To generate focused test cases, the flight simulator system can scan through each of the parameters in the feedback information 380 for the test cases, and identify intervals (e.g., ranges, etc.) of parameter values in the feedback information 380 that are associated with more target conditions than success conditions. Said another way, the flight simulator system can identify narrower boundary conditions for certain parameters that resulted in a number of target conditions that satisfies a threshold. From the ranges of parameter values, the flight simulator system can generate new sets of boundary conditions for each difficult interval of cases. The new boundary conditions can be the maximum and minimum parameter range values identified for ranges of parameter values that resulted in the threshold-satisfying number of target conditions.

Using these new boundary conditions, the flight simulator system can generate additional test cases with parameters within the parameter ranges defined by the new boundary conditions. Generating said new test cases can include, for example, keeping other parameter values constant (e.g., or randomly selecting parameter values within ranges having unmodified boundary conditions, etc.), and then pseudo-randomly sampling values within the identified narrower boundary conditions. The flight simulator system can therefore generate test cases having parameters that are more likely to cause a target condition, as the identified ranges include occurrences of target conditions that are greater than a predetermined threshold. The flight simulator system can generate these new test cases with narrower parameters in response to detecting a target condition when simulating a test case

At STEP 508, the flight simulator system can transmit input of the second test case to the flight autonomy system. After generating the new test cases, the flight simulator system can transmit simulated inputs to the flight autonomy system in accordance with a generated test case, as described herein above. The flight simulator system can continuously evaluate the response signals from the generated test cases by comparing the response signals (e.g., the feedback information, etc.) to expected output values in the generated test cases. The flight simulator system can continuously simulate different test cases within different parameter ranges, as described herein above.

C. Generating Simulated Flight Paths Using Inverse Kinematics

Referring now to FIG. 6, illustrated is a block diagram of an example system 600 for generating simulated flight paths using inverse kinematics, in accordance with one or more implementations. Conventional test cases often rely on manually created or specified values for different test cases. However, such manually created test cases (or simulations) are often a coarse approximation to real-world flight events (e.g., wind, changes in light levels, etc.). The techniques described herein allow for the generation of commands that match the behavior of a real-world flight path, allowing for simulations with higher fidelity than traditional simulation test cases. This is useful for simulation of all aircraft types but is particularly crucial for flight autonomy systems operating on UAVs, as such systems are often required to make precise control decisions in response to a variety of changing real-world conditions that can be difficult to anticipate using traditional simulation techniques. The system 600 can include at least one flight path system 605, and at least one simulator system 105, described herein above in conjunction with FIG. 1. The flight path system 605 can include at least one sensor information identifier 630, at least one flight path determiner 635, at least one instruction generator 340, at least one instruction provider 645, and at least one storage 615. The storage 615 can include flight path data 670, sensor information 675, and flight instructions 680.

Each of the flight path system 605 and the simulator system 105 of the system 600 can be implemented using the hardware components or a combination of software with the hardware components of the computing system 1100 detailed herein in conjunction with FIGS. 11A and 11B. Each of the components of the flight path system 605 (e.g., the sensor information identifier 630, the flight path determiner 635, the instruction generator 640, the instruction provider 645, etc.) can perform any of the functionalities detailed herein. It should be understood that the flight path system 605 depicted in FIG. 6 can perform all of the functionality of the simulator system 105 depicted in FIG. 1, the flight simulator system 305 depicted in FIG. 3, and the turbulence modeling system 805 depicted in FIG. 8.

The flight path system 605 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), a GPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The flight path system 605 can include one or more computing devices or servers that can perform various functions as described herein. The flight path system 605 can include any or all of the components and perform any or all of the functions of the computer system 1100 described herein in conjunction with FIG. 11.

The storage 615 can be a database or other computer-readable memory configured to store or maintain any of the information described herein. The storage 615 can maintain one or more data structures, which can contain, index, or otherwise store each of the values, pluralities, sets, variables, vectors, or thresholds described herein. The storage 615 can be accessed using one or more memory addresses, index values, or identifiers of any item, structure, or region maintained in the storage 615. The storage 615 can be accessed by the components of the flight path system 605, or any other computing device described herein, via a network or another suitable communications interface. In some implementations, the storage 615 can be internal to the flight path system 605. In some implementations, the storage 615 can exist external to the flight path system 605, and can be accessed via a network or another suitable communications interface. In some implementations, the storage 615 can be distributed across many different computer systems or storage elements. The flight path system 605 can store, in one or more regions of the memory of the flight path system 605, or in the storage 615, the results of any or all computations, determinations, selections, identifications, generations, constructions, or calculations in one or more data structures indexed or identified with appropriate values. Any or all values stored in the storage 615 can be accessed by any computing device described herein, such as the flight path system 605, to perform any of the functionalities or functions described herein.

The flight data 670 can include information about a real-world aerial flight conducted with real-world UAVs. The flight data 670 can be stored in the storage 615, for example, by downloading the flight data 670 from a UAV to the storage 615 in the flight path system 605. The flight data 670 can include general information about the aerial flight, such as flight duration, UAV model type, a flight type, or other types of flight metadata including information about events that occurred during the aerial flight. The flight data 670 can include timestamps that correspond to different events. In some implementations, the flight data 670 can include information about actions taken by a controller on the UAV that conducted the flight, such as signals that are generated by the controller to change the UAV's altitude, rotation, velocity, or position in space.

The flight data 670 can be associated with a corresponding set of sensor data 675 captured from the sensors on the UAV during the aerial flight. The sensor data can include, for example, GPS coordinates, acceleration values, velocity values, altitude values, wind speed values, light visibility values, cloud cover values, as well as video captured by cameras (e.g., the cameras 325) during the aerial flight. The sensor information 675 and the flight data 670 can each be stored as a time-series set of values. Item in the series can be stored with a timestamp value that reflects an absolute time that the corresponding data was captured by the UAV during the flight. In addition, the timestamps can reflect the relative time from the beginning of the aerial flight. It should be appreciated that the storage 115 can store sequences from many aerial flights, and that the flight path system 605 can use each of the sequences to generate multiple flight paths for different test cases. In some implementations, each type of information in the sensor information 675 (e.g., GPS coordinates, acceleration values, velocity values, etc.), can be captured from a different sensor, and can be synchronized to a different clock.

The sensor information identifier 630 can identify a sequence of flight data 670 and sensor information 675 captured during an aerial flight. The sensor information identifier 630 can identify the sequence by accessing information associated with a selected aerial flight in the storage 615. In some implementations, the aerial flight can be selected as the most-recently downloaded sequence of flight data 670 and sensor information 675. In some implementations, the aerial flight can be selected in response to an input from an input device, such as a tap from touch screen or a click from a user interface displayed on a display of the flight path system 605. Identifying the flight data 670 and the sensor information 675 can include copying the sequences of flight data 670 and the sensor information 675 to a working region of memory in the flight path system 605.

The sensor information identifier 630 can retrieve a variety of different types of sensor data from multiple sources. In some implementations, the sensor information identifier 630 can identify and retrieve sensor data directly from a UAV, or from a system that is coupled to a UAV. The sensor information identifier 630 can retrieve, from a camera, a sequence of images captured from the aerial flight from one or more cameras (e.g., the cameras 325, etc.) mounted on the UAV. The sensor information identifier 630 can store each image in association with a timestamp identifying when the image was captured, and with a timestamp identifying the amount of time that had elapsed after the flight began when the image was captured. In some implementations, the sensor information identifier 630 can merge or stitch images together to create a merged image. The sensor information identifier 630 can retrieve a sequence of inertial measurement unit data structures from an IMU or other position sensors (e.g., the position sensors 330) mounted on a UAV. The motion data can include a sequence of acceleration values of the UAV during the aerial flight, a sequence of gyroscope values corresponding to angular velocity of the UAV during the aerial flight, or a sequence of magnetometer values corresponding to an absolute direction of the UAV during the aerial flight. The sensor information identifier 630 can retrieve altitude information form a radar sensor mounted on the UAV during the aerial flight.

In some implementations, each type of information in the sensor information 675 (e.g., GPS coordinates, acceleration values, velocity values, etc.), can be captured from a different sensor, and can be synchronized to a different clock. In some implementations, the sensor information identifier 630 can synchronize each different type of sensor information to create a sequence of sensor information having many different types that are all synchronized to a predetermined time step interval. The predetermined time step interval can be received, for example, from a configuration setting or from the simulator system 105. To create a synchronized sequence of sensor data, the sensor information identifier 630 can create a sequence of time steps that correspond to the duration of the flight maintained in the flight data 670. In some implementations, the synchronized series of time steps can be generated from the timestamps associated with the images captured during the aerial flight. The sensor information identifier 630 can synchronize each sensor to the synchronized series of time steps by interpolating the unsynchronized value of the sensor information 675 to determine sensor values at each time step in the synchronized sequence. This has the effect of synchronizing IMU data to GPS data, altitude data, and other sensors that would otherwise be unsynchronized. In some implementations, the sensor information identifier 630 can synchronize the series of images (or video, as the case may be) to the synchronized series of sensor information.

The flight path determiner 635 can determine, based on the sequence of sensor information (e.g., or the synchronized sequence of sensor information, etc.), a flight path of the aerial flight that includes one or more waypoints. The flight path can be a time-series sequence of GPS and radar coordinates (e.g., position and altitude, etc.) of the UAV during the aerial flight. In some implementations, the way points represent positions along predetermined intervals of the aerial flight. In some implementations, the flight path determiner 635 can determine a way point to be an item of sensor information that occurred when the UAV changed course during the flight (e.g., changed direction or altitude, etc.). Each of the way points can be considered a sequence of position data structures that represent the points at which the UAV changed course during the aerial flight. The waypoints can form an ordered list of waypoints that are sorted by time (e.g., the first way point is the position of the UAV at the start of the flight, the final waypoint is the position of the UAV when the flight is completed, etc.). Each waypoint can be separated by a physical distance, which can be calculated by determining a difference in the position positions of a waypoint and the next waypoint in the ordered list. Once the position values of the waypoints have been determined, the waypoints can be stored in association with corresponding time steps of the sequence of synchronized sensor information.

The instruction generator 640 can generate flight instructions 680 for a flight control system that, when executed, cause the flight control system to navigate a simulated movable object along a simulated flight path that corresponds to the plurality of waypoints. The simulated movable object can be a simulated UAV to which the flight control system is attached. The flight instructions 680 can be, for example, one or more commands that cause the flight control system to actuate simulated flight controls and follow the simulated flight path in a simulation. To do so, the instruction generator 640 can utilize inverse kinematics to generate flight instructions 680 that cause the flight control system, for example, to change at least one of a velocity of the movable entity, an altitude of the movable entity, or an orientation of the movable entity to follow the simulated flight path.

The instruction generator 640 can analyze the sequence of sensor information, and determine a difference between two or more values of the sensor information. By way of non-limiting example, consider that the instructions generator 640 can determine a difference between adjacent entries of gyroscope data in the sequence of sensor data. Based on the difference, the instruction generator 640 can generate flight instructions 680 that cause the flight control system to make a corresponding change in orientation (e.g., by actuating one or more fins or applying additional power to one or more rotors, etc.) of a simulated movable entity. Similar approaches can be used to generate flight instructions 680 for other sensor data, such as velocity, altitude, or position. In some implementations, the instruction generator 640 can generate flight instructions 680 that cause a platform (e.g., the platform 410, etc.) to rotate the flight control system while in the simulation according to the change in orientation indicated in the gyroscope sensor information, as depicted in FIG. 4. In some implementations, the instruction generator 640 can generate a sequence of flight instructions 680 for the simulated flight path, which can be used in one or more test cases by the simulator system 105, as described herein above. Each of the sequence of flight instructions 680 can be associated with a respective time step that can be used to identify when in the simulation the flight instruction 680 should be executed by the flight control system.

In some implementations, the instruction generator 640 can generate a test case, similar to the test cases 170, that causes the flight control system to navigate along the simulated flight path. The flight instructions 680 generated for the test case can cause the flight controller to adjust its altitude, position, speed, and orientation in accordance with the flight path, and terminate the test case (e.g., with a success condition, etc.) if the flight controller navigates to the final waypoint on the flight path. If the flight controller fails to reach a waypoint in a predetermined amount of time, or satisfies a predetermined target condition, the flight instructions 680 can cause the test case to indicate that a target condition has been met. Target conditions may include failure conditions.

The instruction provider 645 can provide the flight instructions 680 to the simulator system 105 as part of a test case for the flight control system. The instruction provider 645 can provide the flight instructions 680, for example, via a network or using a suitable communications interface. In some implementations, the instruction provider 645 can provide the flight instructions 680 along with the sequence of images captured by the cameras mounted on the UAV during the real-world aerial flight. The sequence of video images can be provided, for example, to a video input of the flight controller as part of a test case simulated by the simulator system 105. In some implementations, the sequence of images can be displayed on one or more screens, as depicted in FIG. 4.

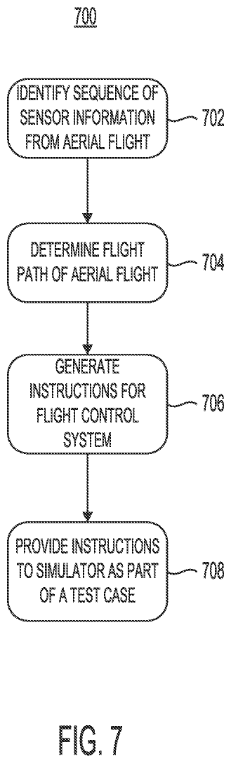

Referring now to FIG. 7, depicted is an illustrative flow diagram of a method 700 for generating simulated flight paths using inverse kinematics. The method 700 can be executed, performed, or otherwise carried out by the flight path system 605, the computer system 1100 described herein in conjunction with FIGS. 11A and 11B, or any other computing devices described herein. In brief overview, at STEP 702, the flight path system can identify a sequence of sensor information from an aerial flight. At STEP 704, the flight path system can determine a flight path of an aerial flight. At STEP 706, the flight path system can generate instructions for a flight control system. At step 708, the flight path system can provide instructions to a simulator as part of a test case.

In further detail, at STEP 702, the flight path system can identify a sequence of sensor information from an aerial flight. The flight path system can identify the sequence by accessing information associated with a selected aerial flight in the memory of the flight path system. In some implementations, the aerial flight can be selected as the most-recently downloaded sequence of flight data and sensor information. In some implementations, the aerial flight can be selected in response to an input from an input device, such as a tap from touch screen or a click from a user interface displayed on a display of the flight path system. Identifying the flight data and the sensor information can include copying the sequences of flight data and the sensor information to a working region of memory in the flight path system.

The flight path system can retrieve a variety of different types of sensor data from multiple sources. In some implementations, the flight path system can identify and retrieve sensor data directly from a UAV, or from a system that is coupled to a UAV. The flight path system can retrieve, from a camera, a sequence of images captured from the aerial flight from one or more cameras (e.g., the cameras 325, etc.) mounted on the UAV. The flight path system can store each image in association with a timestamp identifying when the image was captured, and with a timestamp identifying the amount of time that had elapsed after the flight began when the image was captured. In some implementations, the flight path system can merge or stitch images together to create a merged image. The flight path system can retrieve a sequence of inertial measurement unit data structures from an IMU or other position sensors (e.g., the position sensors 330) mounted on a UAV. The motion data can include a sequence of acceleration values of the UAV during the aerial flight, a sequence of gyroscope values corresponding to angular velocity of the UAV during the aerial flight, or a sequence of magnetometer values corresponding to an absolute direction of the UAV during the aerial flight. The flight path system can retrieve altitude information form a radar sensor mounted on the UAV during the aerial flight.

In some implementations, each type of information in the sensor information (e.g., GPS coordinates, acceleration values, velocity values, etc.), can be captured from a different sensor, and can be synchronized to a different clock. In some implementations, the flight path system can synchronize each different type of sensor information to create a sequence of sensor information having many different types that are all synchronized to a predetermined time step interval. The predetermined time step interval can be received, for example, from a configuration setting or from the simulator system 105. To create a synchronized sequence of sensor data, the flight path system can create a sequence of time steps that correspond to the duration of the flight maintained in the flight data. In some implementations, the synchronized series of time steps can be generated from the timestamps associated with the images captured during the aerial flight. The flight path system can synchronize each sensor to the synchronized series of time steps by interpolating the unsynchronized value of the sensor information to determine sensor values for at each time step in the synchronized sequence. This has the effect of synchronizing IMU data to GPS data, altitude data, and other sensors that would otherwise be unsynchronized. In some implementations, the flight path system can synchronize the series of images (or video, as the case may be) to the synchronized series of sensor information.

At STEP 704, the flight path system can determine a flight path of an aerial flight. The flight path system can determine, based on the sequence of sensor information (e.g., or the synchronized sequence of sensor information, etc.), a flight path of the aerial flight that includes one or more waypoints. The flight path can be a time-series sequence of GPS and radar coordinates (e.g., position and altitude, etc.) of the UAV during the aerial flight. In some implementations, the way points represent positions along predetermined intervals of the aerial flight. In some implementations, the flight path system can determine a way point to be an item of sensor information that occurred when the UAV changed course during the flight (e.g., changed direction or altitude, etc.). Each of the way points can be considered a sequence of position data structures that represent the points at which the UAV changed course during the aerial flight. The waypoints can form an ordered list of waypoints that are sorted by time (e.g., the first way point is the position of the UAV at the start of the flight, the final waypoint is the position of the UAV when the flight is completed, etc.). Each waypoint can be separated by a physical distance, which can be calculated by determining a difference in the position positions of a waypoint and the next waypoint in the ordered list. Once the position values of the waypoints have been determined, the waypoints can be stored in association with corresponding time steps of the sequence of synchronized sensor information.

At STEP 706, the flight path system can generate instructions for a flight control system. The flight path system can generate instructions for a flight control system that, when executed, cause the flight control system to navigate a simulated movable object along a simulated flight path that corresponds to the plurality of waypoints. The simulated movable object can be a simulated UAV to which the flight control system is attached. The instructions can be, for example one or more commands that cause the flight control system to actuate simulated flight controls and follow the simulated flight path in a simulation. To do so, the flight path system can utilize inverse kinematics to generate instructions that cause the flight control system, for example, to change at least one of a velocity of the movable entity, an altitude of the movable entity, or an orientation of the movable entity to follow the simulated flight path.

The flight path system can analyze the sequence of sensor information, and determine a difference between two or more values of the sensor information. By way of non-limiting example, consider that the instructions generator 640 can determine a difference between adjacent entries of gyroscope data in the sequence of sensor data. Based on the difference, the flight path system can generate instructions that cause the flight control system to make a corresponding change in orientation (e.g., by actuating one or more fins or applying additional power to one or more rotors, etc.) of a simulated movable entity. Similar approaches can be used to generate instructions for other sensor data, such as velocity, altitude, or position. In some implementations, the flight path system can generate instructions that cause a platform (e.g., the platform 410, etc.) to rotate the flight control system while in the simulation according to the change in orientation indicated in the gyroscope sensor information, as depicted in FIG. 4. In some implementations, the flight path system can generate a sequence of instructions for the simulated flight path, which can be used in one or more test cases by the simulator system 105, as described herein above. Each of the sequence of instructions can be associated with a respective time step that can be used to identify when in the simulation the instruction should be executed by the flight control system.

In some implementations, the flight path system can generate a test case, similar to the test cases 170, that causes the flight control system to navigate along the simulated flight path. The instructions generated the test case can cause the flight controller to adjust its altitude, position, speed, and orientation in accordance with the flight path, and terminate the test case (e.g., with a success condition, etc.) if the flight controller navigates to the final waypoint on the flight path. If the flight controller fails to reach a waypoint in a predetermined amount of time, or indicates that a target condition has been met, the instructions can cause the test case to indicate the target condition.

At step 708, the flight path system can provide instructions to a simulator as part of a test case. In some implementations, the flight path system can generate a test case, similar to the test cases 170, that causes the flight control system to navigate along the simulated flight path. The instructions generated the test case can cause the flight controller to adjust its altitude, position, speed, and orientation in accordance with the flight path, and terminate the test case (e.g., with a success condition, etc.) if the flight controller navigates to the final waypoint on the flight path. If the flight controller fails to reach a waypoint in a predetermined amount of time, or violates another failure condition, the instructions can cause the test case to indicate a failure condition.

The flight path system can provide the instructions to the simulator system 105 as part of a test case for the flight control system. The flight path system can provide the instructions, for example, via a network or using a suitable communications interface. In some implementations, the flight path system can provide the instructions along with a sequence of images. The images can be generated from virtual cameras mounted on the virtual UAV. The simulated images can be re-projected and augmented from real-world imagery projected onto 3D terrain and sky. In some implementations, the images can be captured from a real-world aerial flight. The sequence of video images can be provided, for example, to a video input of the flight controller as part of a test case simulated by the simulator system 105. In some implementations, the sequence of images can be displayed on one or more screens, as depicted in FIG. 4.

D. Generating Realistic Turbulence Models for Flight Simulators

Real-world flight turbulence necessitates frequent attitude corrections to the fixed-wing aircraft made by the on-board controller to maintain level flight. In the simulator described herein, the turbulence can be considered a function of the velocity of an aircraft. The resulting attitude corrections in roll, pitch, and yaw are used to fit a Fourier series model as described below. Traditional simulation approaches often require manual specification of turbulence values, which can lack realism and often only coarsely approximate turbulence experienced during real-world flights. The techniques described herein provide a means to generate high-fidelity models of turbulence based on sensor data captured from real aircraft test flights.

Referring now to FIG. 8, illustrated is a block diagram of an example system 800 for generating a realistic turbulence model for a flight simulator, in accordance with one or more implementations. The system 800 can include at least one turbulence modeling system 805, and at least one simulator system 105. The turbulence modeling system 805 can include at least one flight data identifier 830, at least one frequency component extractor 835, at least one model establisher 840, at least one turbulence value generator 845, at least one turbulence value provider 850, and at least one storage 815. The storage 815 can include the flight data 670 and the sensor information 675 described herein in conjunction with FIG. 6, and can include turbulence data 880.

Each of the turbulence modeling system 805 and the simulator system 105 of the system 800 can be implemented using the hardware components or a combination of software with the hardware components of the computing system 1100 detailed herein in conjunction with FIGS. 11A and 11B. Each of the components (e.g., the flight data identifier 830, the frequency component extractor 835, the model establisher 840, the turbulence value generator 845, the turbulence value provider 850, etc.) of the turbulence modeling system 805 can perform any of the functionalities detailed herein.

The turbulence modeling system 805 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), a GPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The turbulence modeling system 805 can include one or more computing devices or servers that can perform various functions as described herein. The turbulence modeling system 805 can include any or all of the components and perform any or all of the functions of the computer system 1100 described herein in conjunction with FIG. 11.

The storage 815 can be a database configured to store and/or maintain any of the information described herein. The storage 815 can maintain one or more data structures, which can contain, index, or otherwise store each of the values, pluralities, sets, variables, vectors, or thresholds described herein. The storage 815 can be accessed using one or more memory addresses, index values, or identifiers of any item, structure, or region maintained in the storage 815. The storage 815 can be accessed by the components of the turbulence modeling system 805, or any other computing device described herein, via a network or a suitable communications interface. In some implementations, the storage 815 can be internal to the turbulence modeling system 805. In some implementations, the storage 815 can exist external to the turbulence modeling system 805, and can be accessed via a network or a suitable communications interface. In some implementations, the storage 815 can be distributed across many different computer systems or storage elements. The turbulence modeling system 805 can store, in one or more regions of the memory of the turbulence modeling system 805, or in the storage 815, the results of any or all computations, determinations, selections, identifications, generations, constructions, or calculations in one or more data structures indexed or identified with appropriate values. Any or all values stored in the storage 815 can be accessed by any computing device described herein, such as the turbulence modeling system 805, to perform any of the functionalities or functions described herein.

The storage 815 can include the flight data 670 and the sensor information 675, each of which are detailed herein above in conjunction with FIG. 6. The flight data 670 and the sensor information 675 used for turbulence modeling can be that which represents a level flight pattern (e.g., not making any turns or changes in altitude, speed, or orientation, etc.). The storage 815 can also include turbulence data 880, which can include turbulence values for the simulator that are generated based on the flight data 670 and the sensor information 675, as described herein below. The turbulence data 880 can be a time-series data that corresponds to a synchronized set of timestamps (e.g., the timestamps for the flight paths generated above, etc.), or can be synchronized to the timestamps of the items of the sensor data 675.

The flight data identifier 830 can be similar to the sensor information identifier 630 described herein in conjunction with FIG. 6, and can identify a sequence of sensor information 675 captured from a level aerial flight. The flight data identifier 830 can identify the sequence by accessing the flight data 670 and the sensor information 675 associated with a level aerial flight in the storage 815. In some implementations, the aerial flight can be selected in response to an input from an input device, such as a tap from touch screen or a click from a user interface displayed on a display of the turbulence modeling system 805. Identifying the sensor information 675 can include copying the sequences of flight data 670 and the sensor information 675 to a working region of memory in the turbulence modeling system 805.

The flight data identifier 830 can retrieve a sequence of inertial measurement unit data structures from an IMU or other position sensors (e.g., the position sensors 330) mounted on an aircraft that conducted the aerial flight, or from the sensor information 675 in the storage 815. From the IMU data, the flight data identifier 830 can retrieve one or more of a sequence of roll values, a sequence of pitch values, or a sequence of yaw values. The roll, pitch, and yaw values can be the absolute angles of rotation of the aircraft that conducted the aerial flight, or can be the changes in the rotation (e.g., rates of orientation as returned by a gyroscope, etc.) of the aircraft during the flight path. Each item of the sequence of sensor information can be associated with a respective timestamp that identifies the time at which the item of sensor data was captured. The flight data identifier 830 can record a time-series data structure that includes the sequence of roll, yaw, and pitch values along with timestamp values.

The frequency component extractor 835 can extract a frequency component from the time-series sequence of sensor information. For example, the frequency component extractor 835 can receive a time domain representation of the sensor information and generate a frequency domain representation of the sensor information. The frequency component can be determined by applying a Fourier transform of at least one of the sequence of roll values, the sequence of pitch values, or the sequence of yaw values in the sensor information. For example, the frequency component extractor 835 can utilize the fast-Fourier transform algorithm to extract the top N frequencies from the time series of the sequence of roll, yaw, and pitch values. The frequency component can be a set of frequency components. For example, the frequency component extractor 835 can extract a predetermined number of the top (e.g., largest, when compared to other frequency components present in the Fourier transform, etc.) frequency components that contribute to each sequence of yaw, roll, or pitch values. The frequency component extractor 835 can identify the largest frequency components by comparing each frequency to each other frequency in the resulting Fourier transform, and copying a predetermined number of frequency components having the largest magnitude to another region of computer memory. In some implementations, the frequency component extractor 835 can extract a phase offset value for each extracted frequency component, which can also be stored in computer memory in association with the frequency component.

The model establisher 840 can establish, based on the frequency component(s) extracted from the sequence of sensor information, a model of attitude corrections that occurred during the aerial flight. The model can be a Fourier series model, similar to the model shown below:

$${a}_{0} + {\sum }_{i = 1}^{N} cos {a}_{i} cos ( 2 π {f}_{i} t + {p}_{i} ) + {b}_{i} sin ( 2 π {f}_{i} t + {p}_{i} )$$

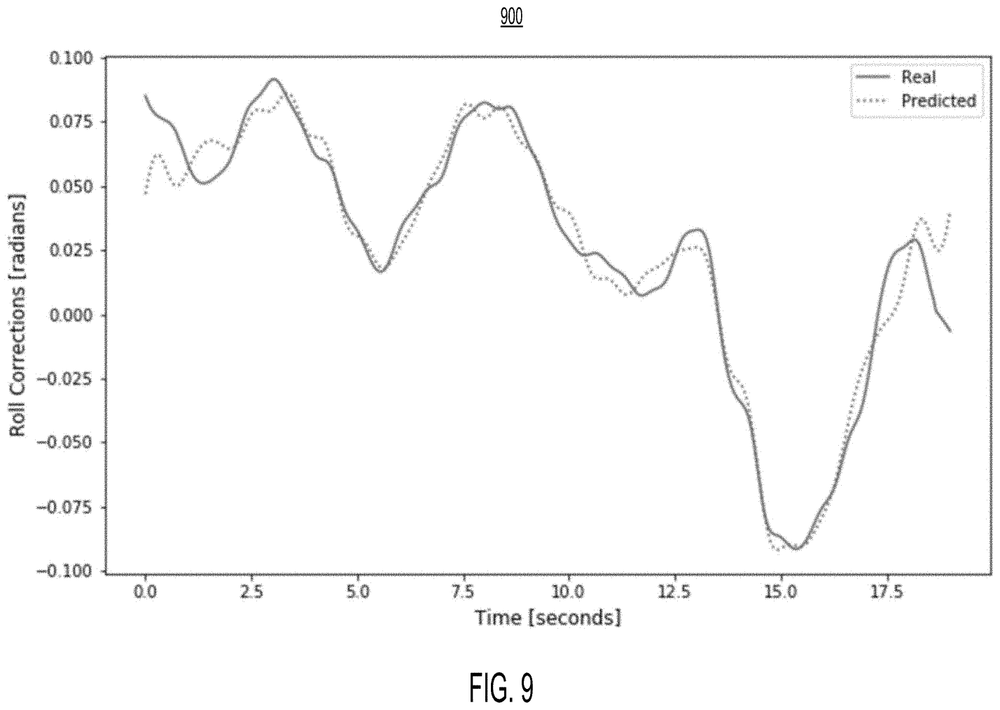

In the model above, each of the values of a and b can be Fourier series coefficients that capture the amplitude of turbulence, each of the values of f can be frequency the components extracted from the Fourier transform, and each of the values of p can be phase values, each of which capture the frequency of turbulence values. The value oft can be a time-step value used to calculate the final turbulence output. The value N can be the predetermined number of frequency components extracted from the time-series sensor data (e.g., 12, etc.). To complete the model, each of the values of a and b can be calculated iteratively until there is an acceptable convergence between the model estimates and the real-world time series gyroscope values. An example of such convergence is shown in FIG. 9.

The model establishment 840 can establish an individual model for roll corrections, yaw corrections, and pitch corrections based on the IMU data for those respective values and using the process above. Collectively, these can form a model of general attitude corrections that occurred during the aerial flight. In some implementations, the model establisher 840 can change or alter the model of turbulence based on the velocity value of the aircraft that performed the aerial flight. For example, each of the coefficients can be scaled by amount proportional to the ratio of the desired simulation velocity to the actual velocity of the aircraft during level flight. In some implementations, the scaled coefficients can be used when generating the turbulence values for the simulated aerial flight.

The turbulence value generator 845 can generate a series of simulated turbulence values based on the model of attitude corrections. The series of simulated turbulence values can be generated using at least one of the models for roll corrections, the model for pitch corrections, or the model for yaw corrections. For example, using the model shown above with the determined coefficient values (e.g., that are proportional to the velocity of the aircraft at a given time-step, etc.), the turbulence value generator 845 can solve the model above using a sequence of time step values as the value t. By solving for the whole sequence of t values, each model (e.g., the roll, pitch, and yaw models, etc.) can output a corresponding sequence of simulated roll, pitch, or yaw correction amounts for use in test cases. The roll, pitch, yaw, or roll correction amounts can be generated such that they can be used by the simulator system 105 as telemetry data for test cases. In some implementations, the turbulence values can be synchronized to a video stream that was captured during the aerial flight.

The turbulence value provider 850 can provide the series of simulated turbulence values to the simulator system 105 as part of a test for a flight control system (e.g., the flight autonomy system 320, etc.). The turbulence value provider 850 can provide the series of simulated turbulence values to the simulation 120 in one or more messages via a network or another suitable communications interface. In some implementations, each item in the sequence of turbulence data 880 can be provided with a corresponding time-step value.

The series of simulated turbulence values can be synchronized, for example, to a series of time steps for a simulation provided by the simulator system 105. In such implementations, the turbulence value generator 845 can generate the sequence of simulator values using the provided sequence of time steps as the value t. In some implementations, the turbulence value provider 850 can synchronize the series of simulated turbulence values to one or more frames of a video stream provided by the simulator system. The turbulence value provider 850 can retrieve the video stream from the sensor information 675, and can identify a frequency value of a video stream. The frequency value of the video stream can be the rate at which the frames of the video stream are displayed. In some implementations, a multiple of the video stream frequency value can be used (e.g., two turbulence values for each frame, etc.).

The turbulence value provider 850 can interpolate the series of telemetry data to match the frame rate of the video stream. For example, in the event that the time-step rate of the series of turbulence values does not match that of the frame rate of the video stream, the sequence of turbulence values of the generated sequence of turbulence data 880 can be used with an interpolation algorithm, such as cubic spline interpolation, to match the frequency of the video stream. The turbulence value provider 850 can then associate every frame of the video with a corresponding turbulence value. This post-processed telemetry data can then be provided to the simulator system 105 for use in a simulation or replication. In some implementations, the telemetry data can be provided to the simulator system 105 in conjunction with the video stream.

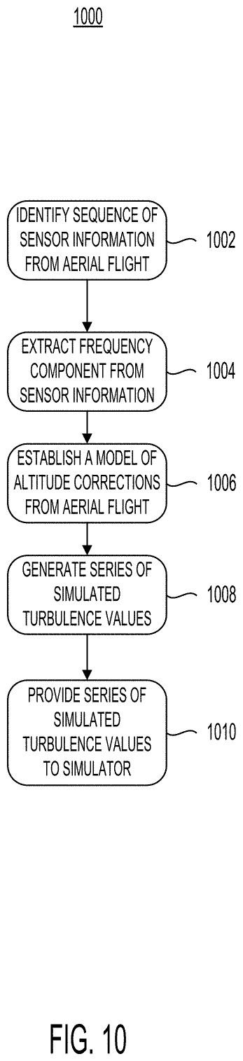

Referring now to FIG. 10, depicted is an illustrative flow diagram of a method 1000 for generating a realistic turbulence model for a flight simulator. The method 1000 can be executed, performed, or otherwise carried out by the turbulence modeling system 805, the computer system 1100 described herein in conjunction with FIGS. 11A and 11B, or any other computing devices described herein. In brief overview, at STEP 1002, the turbulence modeling system (e.g., the turbulence modeling system 805, etc.) can identify a sequence of sensor information from an aerial flight. At STEP 1004, the turbulence modeling system can extract a frequency component from the series of sensor information. At STEP 1006, the turbulence modeling system can establish a model of attitude corrections from the aerial flight. At STEP 1008, the turbulence modeling system can generate a series of simulated turbulence values. At STEP 1010, the turbulence modeling system can provide the series of simulated turbulence values to the simulator.

In brief overview, at STEP 1002, the turbulence modeling system (e.g., the turbulence modeling system 805, etc.) can identify a sequence of sensor information from an aerial flight. The turbulence modeling system can identify the sequence by accessing flight data (e.g., the flight data 670, etc.) and sensor information (e.g., the sensor information 675, etc.) associated with a level aerial flight in the memory of the turbulence modeling system. In some implementations, the aerial flight can be selected in response to an input from an input device, such as a tap from touch screen or a click from a user interface displayed on a display of the turbulence modeling system. Identifying the sensor information can include copying the sequences of flight data and the sensor information to a working region of memory in the turbulence modeling system.

The turbulence modeling system can retrieve a sequence of inertial measurement unit data structures from an IMU or other position sensors (e.g., the position sensors 330) mounted on a aircraft that conducted the aerial flight, or from the sensor information in the storage 815. From the IMU data, the turbulence modeling system can retrieve one or more of a sequence of a sequence of roll values, a sequence of pitch values, or a sequence of yaw values. The roll, pitch, and yaw values can be the absolute angles of rotation of the aircraft that conducted the aerial flight, or can be the changes in the rotation (e.g., rates of orientation as returned by a gyroscope, etc.) of the aircraft during the flight path. Each item of the sequence of sensor information can be associated with a respective timestamp that identifies the time at which the item of sensor data was captured. The turbulence modeling system can generate a time-series data structure including the sequence of IMU data structures by sorting the sequence of roll, yaw, and pitch values along with timestamp values.

At STEP 1004, the turbulence modeling system can extract a frequency component from the series of sensor information. The frequency component can be determined by determining a Fourier transform of at least one of the sequence of roll values, the sequence of pitch values, or the sequence of yaw values in the sensor information. For example, the turbulence modeling system can utilize the fast-Fourier transform algorithm to create a Fourier transform of the sequence of roll, yaw, and pitch values. The frequency component can be a set of frequency components. For example, the turbulence modeling system can extract a predetermined number of the top (e.g., largest, when compared to other frequency components present in the Fourier transform, etc.) frequency components that contribute to each sequence of yaw, roll, or pitch values. The turbulence modeling system can identify the largest frequency components by comparing each frequency to each other frequency in the resulting Fourier transform, and copying a predetermined number of frequency components having the largest magnitude to another region of computer memory. In some implementations, the turbulence modeling system can extract a phase offset values for each extracted frequency component, which can also be stored in computer memory in association with the frequency component.

At STEP 1006, the turbulence modeling system can establish a model of attitude corrections from the aerial flight. The turbulence modeling system can establish, based on the frequency component(s) extracted from the sequence of sensor information, a model of attitude corrections that occurred during the aerial flight. The model can be a Fourier series model, similar to the model shown below:

$${a}_{0} + {\sum }_{i = 1}^{N} cos {a}_{i} cos ( 2 π {f}_{i} t + {p}_{i} ) + {b}_{i} sin ( 2 π {f}_{i} t + {p}_{i} )$$

In the model above, each of the values of a and b can be Fourier series coefficients that capture the amplitude of turbulence, each of the values off can be frequency the components extracted from the Fourier transform, and each of the values ofp can be phase values, each of which capture the frequency of turbulence values. The value oft can be a time-step value used to calculate the final turbulence output. The value N can be the predetermined number of frequency components extracted from the time-series sensor data (e.g., 12, etc.). To complete the model, each of the values of a and b can be calculated iteratively until there is an acceptable convergence between the model estimates and the real-world time series gyroscope values. An example of such convergence is shown in FIG. 9.

The turbulence modeling system can establish an individual model for roll corrections, yaw corrections, and pitch corrections based on the IMU data for those respective values and using the process above. Collectively, these can form a model of general attitude corrections that occurred during the aerial flight. In some implementations, the turbulence modeling system can change or alter the model of turbulence based on the velocity value of the aircraft that that performed the aerial flight. For example, each of the coefficients can be scaled by amount proportional to the ratio of the desired simulation velocity to the actual velocity of the aircraft during level flight. In some implementations, the scaled coefficients can be used when generating the turbulence values for the simulated aerial flight.

At STEP 1008, the turbulence modeling system can generate a series of simulated turbulence values. The turbulence modeling system can generate a series of simulated turbulence values based on the model of attitude corrections. The series of simulated turbulence values can be generated using at least one of the model for roll corrections, the model for pitch corrections, or the model for yaw corrections. For example, using the model shown above with the determined coefficient values (e.g., that are proportional to the velocity of the aircraft at a given time-step, etc.), the turbulence modeling system can solve the model above using a sequence of time step values as the value t. By solving for the whole sequence of t values, each model (e.g., the roll, pitch, and yaw models, etc.) can output a corresponding sequence of simulated roll, pitch, or yaw correction amounts for use in test cases. The roll, pitch, yaw, or roll correction amounts can be generated such that they can be used by the simulator system 105 as telemetry data for test cases. In some implementations, the turbulence values can be synchronized to a video stream that was captured during the aerial flight.

At STEP 1010, the turbulence modeling system can provide the series of simulated turbulence values to the simulator. The turbulence modeling system can provide the series of simulated turbulence values to a simulator (e.g., the simulator system 105, etc.) as part of a test for a flight control system (e.g., the flight autonomy system 320, etc.). The turbulence modeling system can provide the series of simulated turbulence values to the simulation 120 in one or more messages via a network or another suitable communications interface. In some implementations, each item in the sequence of turbulence data can be provided with a corresponding time-step value.

The series of simulated turbulence values can be synchronized, for example, to a series of time steps for a simulation provided by a simulator system. In such implementations, the turbulence modeling system can generate the sequence of simulator values using the provided sequence of time steps as the value t. In some implementations, the turbulence modeling system can synchronize the series of simulated turbulence values to one or more frames of a video stream provided by the simulator system. The turbulence modeling system can retrieve the video stream from the sensor information, and can identify a frequency value of a video stream. The frequency value of the video stream can be the rate at which the frames of the video stream are displayed. In some implementations, a multiple of the video stream frequency value can be used (e.g., two turbulence values for each frame, etc.).

The turbulence modeling system can interpolate the series of telemetry data to match the frame rate of the video stream. For example, in the event that the time-step rate of the series of turbulence values does not match that of the frame rate of the video stream, the sequence of turbulence values of the generated sequence of turbulence data can be used with an interpolation algorithm, such as cubic spline interpolation, to match the frequency of the video stream. The turbulence modeling system can then associate every frame of the video with a corresponding turbulence value. This post-processed telemetry data can then be provided to the simulator system 105 for use in a simulation or replication. In some implementations, the telemetry data can be provide to the simulator system 105 in conjunction with the video stream.

E. Computing Environment

FIGS. 11A and 11B depict block diagrams of a computing device 1100. As shown in FIGS. 11A and 11B, each computing device 1100 includes a central processing unit 1121, and a main memory unit 1122. As shown in FIG. 11A, a computing device 1100 can include a storage device 1128, an installation device 1116, a network interface 1118, an I/O controller 1123, display devices 1124a-1124n, a keyboard 1126 and a pointing device 1127, e.g. a mouse. The storage device 1128 can include, without limitation, an operating system, software, and software of visual situational awareness system (VSAS) 800. As shown in FIG. 11B, each computing device 1100 can also include additional optional elements, e.g. a memory port 1103, a bridge 1170, one or more input/output devices 1130a-1130n (generally referred to using reference numeral 1130), and a cache memory 1140 in communication with the central processing unit 1121.

The central processing unit 1121 is any logic circuitry that responds to and processes instructions fetched from the main memory unit 1122. In many embodiments, the central processing unit 1121 is provided by a microprocessor unit, e.g.: those manufactured by Intel Corporation of Mountain View, Calif.; those manufactured by Motorola Corporation of Schaumburg, Ill.; the ARM processor (from, e.g., ARM Holdings and manufactured by ST, TI, ATMEL, etc.) and TEGRA system on a chip (SoC) manufactured by Nvidia of Santa Clara, Calif.; stand-alone ARM processors; the POWER7 processor, those manufactured by International Business Machines of White Plains, N.Y.; or those manufactured by Advanced Micro Devices of Sunnyvale, Calif.; or field programmable gate arrays (“FPGAs”) from Altera in San Jose, Calif., Intel Corporation, Xlinix in San Jose, Calif., or MicroSemi in Aliso Viejo, Calif., etc. The computing device 1100 can be based on any of these processors, or any other processor capable of operating as described herein. The central processing unit 1121 can utilize instruction level parallelism, thread level parallelism, different levels of cache, and multi-core processors. A multi-core processor can include two or more processing units on a single computing component. Examples of multi-core processors include the AMD PHENOM IIX2, INTEL CORE i5 and INTEL CORE i7.

Main memory unit 1122 can include one or more memory chips capable of storing data and allowing any storage location to be directly accessed by the microprocessor 1121. Main memory unit 1122 can be volatile and faster than storage 1128 memory. Main memory units 1122 can be Dynamic random access memory (DRAM) or any variants, including static random access memory (SRAM), Burst SRAM or SynchBurst SRAM (B SRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 1122 or the storage 1128 can be non-volatile; e.g., non-volatile read access memory (NVRAIVI), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 1122 can be based on any of the above described memory chips, or any other available memory chips capable of operating as described herein. In the embodiment shown in FIG. 11A, the processor 1121 communicates with main memory 1122 via a system bus 1150 (described in more detail below). FIG. 11B depicts an embodiment of a computing device 1100 in which the processor communicates directly with main memory 1122 via a memory port 1103. For example, in FIG. 11B the main memory 1122 can be DRDRAM.

FIG. 11B depicts an embodiment in which the main processor 1121 communicates directly with cache memory 1140 via a secondary bus, sometimes referred to as a backside bus. In other embodiments, the main processor 1121 communicates with cache memory 1140 using the system bus 1150. Cache memory 1140 typically has a faster response time than main memory 1122 and is typically provided by SRAM, BSRAM, or EDRAM. In the embodiment shown in FIG. 11B, the processor 1121 communicates with various I/O devices 1130 via a local system bus 1150. Various buses can be used to connect the central processing unit 1121 to any of the I/O devices 1130, including a PCI bus, a PCI-X bus, or a PCI-Express bus, or a NuBus. For embodiments in which the I/O device is a video display 1124, the processor 1121 can use an Advanced Graphics Port (AGP) to communicate with the display 1124 or the I/O controller 1123 for the display 1124. FIG. 11B depicts an embodiment of a computer 1100 in which the main processor 1121 communicates directly with I/O device 1130b or other processors 1121′ via HYPERTRANSPORT, RAPIDIO, or INFINIBAND communications technology. FIG. 11B also depicts an embodiment in which local busses and direct communication are mixed: the processor 1121 communicates with I/O device 1130a using a local interconnect bus while communicating with I/O device 1130b directly.

A wide variety of I/O devices 1130a-1130n can be present in the computing device 1100. Input devices can include keyboards, mice, trackpads, trackballs, touchpads, touch mice, multi-touch touchpads and touch mice, microphones (analog or MEMS), multi-array microphones, drawing tablets, cameras, single-lens reflex camera (SLR), digital SLR (DSLR), CMOS sensors, CCDs, accelerometers, inertial measurement units, infrared optical sensors, pressure sensors, magnetometer sensors, angular rate sensors, depth sensors, proximity sensors, ambient light sensors, gyroscopic sensors, or other sensors. Output devices can include video displays, graphical displays, speakers, headphones, inkjet printers, laser printers, and 3D printers.

Devices 1130a-1130n can include a combination of multiple input or output devices, including, e.g., Microsoft KINECT, Nintendo Wiimote for the WII, Nintendo WII U GAMEPAD, or Apple IPHONE. Some devices 1130a-1130n allow gesture recognition inputs through combining some of the inputs and outputs. Some devices 1130a-1130n provides for facial recognition which can be utilized as an input for different purposes including authentication and other commands. Some devices 1130a-1130n provides for voice recognition and inputs, including, e.g., Microsoft KINECT, SIRI for IPHONE by Apple, Google Now or Google Voice Search.

Additional devices 1130a-1130n have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 1130a-1130n, display devices 1124a-1124n or group of devices can be augmented reality devices. The I/O devices can be controlled by an I/O controller 1121 as shown in FIG. 11A. The I/O controller 1121 can control one or more I/O devices, such as, e.g., a keyboard 126 and a pointing device 1127, e.g., a mouse or optical pen. Furthermore, an I/O device can also provide storage and/or an installation medium 116 for the computing device 1100. In still other embodiments, the computing device 1100 can provide USB connections (not shown) to receive handheld USB storage devices. In further embodiments, an I/O device 1130 can be a bridge between the system bus 1150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 1124a-1124n can be connected to I/O controller 1121. Display devices can include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays can use, e.g. stereoscopy, polarization filters, active shutters, or autostereoscopy. Display devices 1124a-1124n can also be a head-mounted display (HMD). In some embodiments, display devices 1124a-1124n or the corresponding I/O controllers 1123 can be controlled through or have hardware support for OPENGL or DIRECTX API or other graphics libraries.

In some embodiments, the computing device 1100 can include or connect to multiple display devices 1124a-1124n, which each can be of the same or different type and/or form. As such, any of the I/O devices 1130a-1130n and/or the I/O controller 1123 can include any type and/or form of suitable hardware, software, or combination of hardware and software to support, enable or provide for the connection and use of multiple display devices 1124a-1124n by the computing device 1100. For example, the computing device 1100 can include any type and/or form of video adapter, video card, driver, and/or library to interface, communicate, connect or otherwise use the display devices 1124a-1124n. In one embodiment, a video adapter can include multiple connectors to interface to multiple display devices 1124a-1124n. In other embodiments, the computing device 1100 can include multiple video adapters, with each video adapter connected to one or more of the display devices 1124a-1124n. In some embodiments, any portion of the operating system of the computing device 1100 can be configured for using multiple displays 1124a-1124n. In other embodiments, one or more of the display devices 1124a-1124n can be provided by one or more other computing devices 1100a or 1100b connected to the computing device 1100, via the network 140. In some embodiments software can be designed and constructed to use another computer's display device as a second display device 1124a for the computing device 1100. For example, in one embodiment, an Apple iPad can connect to a computing device 1100 and use the display of the device 1100 as an additional display screen that can be used as an extended desktop. One ordinarily skilled in the art will recognize and appreciate the various ways and embodiments that a computing device 1100 can be configured to have multiple display devices 1124a-1124n.

Referring again to FIG. 11A, the computing device 1100 can comprise a storage device 1128 (e.g. one or more hard disk drives or redundant arrays of independent disks) for storing an operating system or other related software, and for storing application software programs such as any program related to the software for the VSAS 800. Examples of storage device 1128 include, e.g., hard disk drive (HDD); optical drive including CD drive, DVD drive, or BLU-RAY drive; solid-state drive (SSD); USB flash drive; or any other device suitable for storing data. Some storage devices can include multiple volatile and non-volatile memories, including, e.g., solid state hybrid drives that combine hard disks with solid state cache. Some storage device 1128 can be non-volatile, mutable, or read-only. Some storage device 1128 can be internal and connect to the computing device 1100 via a bus 1150. Some storage device 1128 can be external and connect to the computing device 1100 via a I/O device 1130 that provides an external bus. Some storage device 1128 can connect to the computing device 1100 via the network interface 1118 over a network, including, e.g., the Remote Disk for MACBOOK AIR by APPLE. Some computing devices 1100 may not require a non-volatile storage device 1128 and can be thin clients or zero clients. Some storage device 1128 can also be used as an installation device 1116, and can be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Computing device 1100 can also install software or applications from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc.

Furthermore, the computing device 1100 can include a network interface 1118 to interface to the network 140 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 1100 communicates with other computing devices 1100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 1118 can comprise a built-in network adapter, network interface card, PCMCIA network card, EXPRESSCARD network card, card bus network adapter, wireless network adapter, USB network adapter, modem or any other device suitable for interfacing the computing device 1100 to any type of network capable of communication and performing the operations described herein.

A computing device 1100 of the sort depicted in FIG. 11A can operate under the control of an operating system, which controls scheduling of tasks and access to system resources. The computing device 1100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 11000, WINDOWS Server 2012, WINDOWS CE, WINDOWS Phone, WINDOWS XP, WINDOWS VISTA, and WINDOWS 11, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, can be used on zero clients or thin clients, including, e.g., CHROMEBOOKS.

The computer system 1100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 1100 has sufficient processor power and memory capacity to perform the operations described herein. In some embodiments, the computing device 1100 can have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 1100 is a gaming system. For example, the computer system 1100 can comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, or an XBOX 360 device manufactured by the Microsoft Corporation of Redmond, Wash., or an OCULUS RIFT or OCULUS VR device manufactured by OCULUS VR, LLC of Menlo Park, Calif.

In some embodiments, the computing device 1100 is a digital audio player such as the Apple IPOD, IPOD Touch, and IPOD NANO lines of devices, manufactured by Apple Computer of Cupertino, Calif. Some digital audio players can have other functionality, including, e.g., a gaming system or any functionality made available by an application from a digital application distribution platform. For example, the IPOD Touch can access the Apple App Store. In some embodiments, the computing device 1100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 1100 is a tablet e.g. the IPAD line of devices by Apple; GALAXY TAB family of devices by Samsung; or KINDLE FIRE, by Amazon.com, Inc. of Seattle, Wash. In other embodiments, the computing device 1100 is an eBook reader, e.g. the KINDLE family of devices by Amazon.com, or NOOK family of devices by Barnes & Noble, Inc. of New York City, N.Y.

In some embodiments, the communications device 1100 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc.; or a Motorola DROID family of smartphones. In yet another embodiment, the communications device 1100 is a laptop or desktop computer equipped with a web browser and a microphone and speaker system, e.g. a telephony headset. In these embodiments, the communications devices 1100 are web-enabled and can receive and initiate phone calls. In some embodiments, a laptop or desktop computer is also equipped with a webcam or other video capture device that enables video chat and video call.

In some embodiments, the status of one or more machines 1100 in the network are monitored, generally as part of network management. In one of these embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

Having now described some illustrative implementations and implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation can be included in at least one implementation. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein can be embodied in other specific forms without departing from the characteristics thereof. Although the examples provided can be useful for generating test cases for a simulator based on simulated events, the systems and methods described herein can be applied to other environments. The foregoing implementations are illustrative rather than limiting of the described systems and methods. The scope of the systems and methods described herein can thus be indicated by the appended claims, rather than the foregoing description, and changes that come within the meaning and range of equivalency of the claims are embraced therein.

1. A method of generating test cases for a simulator based on simulated events, comprising:
monitoring, by one or more processors coupled to memory, an output from a first simulation of a first test case;
detecting, by the one or more processors, based on the output from the first simulation, a target condition resulting from the first test case;
identifying, by the one or more processors, based on the target condition, first simulation parameters of the first test case associated with the target condition;
generating, by the one or more processors, a second test case having second simulation parameters by modifying the first simulation parameters of the first test case; and
outputting, by the one or more processors, the second test case.

2. The method of claim 1, wherein the first test case is selected from a plurality of first test cases having simulation parameters within a first parameter range;
wherein generating the second test case comprises generating a plurality of second test cases having a simulation parameter within a second parameter range determined based on narrowing the first parameter range; and
wherein generating the second test case comprises selecting the second test case from the plurality of second test cases.

3. The method of claim 2, wherein the simulation parameter within the second parameter range is selected for each of the plurality of second test cases based on the target condition resulting from the first test case.

4. The method of claim 2, further comprising determining the second parameter range based on the first parameter range and a rate of the target condition.

5. The method of claim 2, wherein the second test case is stochastically sampled from the plurality of second test cases.

6. The method of claim 1, wherein identifying the first simulation parameters of the first test case comprises determining a simulation time at which the target condition occurred;
wherein identifying the first simulation parameters of the first test case comprises identifying one or more conditions of the first test case that occurred prior to the simulation time at which the target condition occurred; and
wherein identifying the first simulation parameters of the first test case comprises extracting the first simulation parameters based on the one or more conditions of the first test case.

7. The method of claim 5, wherein each of the first simulation parameters are associated with a priority value; and
wherein extracting the first simulation parameters comprises extracting a subset of the first simulation parameters having a respective priority value that satisfies a threshold.

8. The method of claim 1, wherein the first simulation parameters and the second simulation parameters comprise at least one of a velocity value, an altitude value, a location value, a cloud cover value, a cloud type value, a roll value, a pitch value, a yaw value, environmental lighting conditions, or environmental objects.

9. The method of claim 1, wherein monitoring the output from the first simulation of the first test case comprises providing, to the first simulation, one or more events of the first test case at predetermined time intervals; and
wherein monitoring the output from the first simulation of the first test case comprises receiving, from the first simulation, feedback information generated in response to the one or more events of the first test case as the output from the first simulation.

10. The method of claim 1, wherein detecting the target condition resulting from the first simulation comprises determining a difference between the output from the first simulation and an expected output value of the first test case; and
wherein detecting the target condition resulting from the first simulation comprises detecting the target condition responsive to the difference exceeding a predetermined threshold.

11. A system configured for generating test and train cases for a simulator based on simulated events, the system comprising:
one or more processors coupled to memory, the one or more processors configured to:
monitor an output from a first simulation of a first test case;
detect, based on the output from the first simulation, a target condition resulting from the first test case;
identify, based on the target condition, first simulation parameters of the first test case associated with the target condition;
generate a second test case having second simulation parameters by modifying the first simulation parameters of the first test case; and
output the second test case.

12. The system of claim 11, wherein the first test case is selected from a plurality of first test cases having simulation parameters within a first parameter range;
wherein generating the second test case comprises generating a plurality of second test cases having a simulation parameter within a second parameter range, wherein the second parameter range determined based on narrowing the first parameter range; and
wherein generating the second test case comprises selecting the second test case from the plurality of second test cases.

13. The system of claim 12, wherein the simulation parameter within the second parameter range is selected for each of the plurality of second test cases based on the target condition resulting from the first test case.

14. The system of claim 12, wherein the one or more processors are further configured to determine the second parameter range based on the first parameter range and a simulation rate of the target condition.

15. The system of claim 12, wherein the second test case is stochastically sampled from the plurality of second test cases.

16. The system of claim 11, wherein identifying the first simulation parameters of the first test case comprises determining a simulation time at which the target condition occurred;
wherein identifying the first simulation parameters of the first test case comprises identifying one or more conditions of the first test case that occurred prior to the simulation time at which the target condition occurred; and
wherein identifying the first simulation parameters of the first test case comprises extracting the first simulation parameters based on the one or more conditions of the first test case.

17. The system of claim 15, wherein each of the first simulation parameters are associated with a priority value; and
wherein extracting the first simulation parameters comprises extracting a subset of the first simulation parameters having a respective priority value that satisfies a threshold.

18. The system of claim 11, wherein the first simulation parameters and the second simulation parameters comprise at least one of a velocity value, an altitude value, a location value, a cloud cover value, a cloud type value, a roll value, a pitch value, a yaw value, environmental lighting conditions, or environmental objects.

19. The system of claim 11, wherein monitoring the output from the first simulation of the first test case comprises providing, to the first simulation, one or more conditions of the first test case at predetermined time intervals; and
wherein monitoring the output from the first simulation of the first test case comprises receiving, from the first simulation, feedback information generated in response to the one or more conditions of the first test case as the output from the first simulation.

20. The system of claim 11, wherein detecting the target condition resulting from the first simulation comprises determining a difference between the output from the first simulation and an expected output value of the first test case; and
wherein detecting the target condition resulting from the first simulation comprises detecting the target condition responsive to the difference exceeding a predetermined threshold.

21-80. (canceled)
